(19) United States
(12) Patent Application Publication
(10) Pub. No.: US 2013/0226318 A1
(43) Pub. Date: Aug. 29, 2013

(54) PROCESS TRANSFORMATION AND TRANSITIONING APPARATUSES, METHODS AND SYSTEMS

(71) Applicants: Dariusz Procyk, Krakow (PL); Christopher Stancombe, Reading (GB); Jonathan Bell, Port Talbot (GB); Andrzej Hutniczak, Michalowice (PL)

(72) Inventors: Dariusz Procyk, Krakow (PL); Christopher Stancombe, Reading (GB); Jonathan Bell, Port Talbot (GB); Andrzej Hutniczak, Michalowice (PL)

(21) Appl. No.: 13/624,576

(22) Filed: Sep. 21, 2012

Related U.S. Application Data
(60) Provisional application No. 61/537,806, filed on Sep. 22, 2011.

(51) Int. Cl. G05B 13/02

(52) U.S. Cl. CPC G05B 13/021
USPC 700/33

(57) ABSTRACT

The PROCESS TRANSFORMATION AND TRANSITIONING APPARATUSES, METHODS AND SYSTEMS (“PTT”) transform unoptimized locally-deployable baseline processes via PTT components into custom globally optimized processes and transition materials. In one implementation, the PTT obtains a baseline process optimization request via a processor, including a unoptimized locally-deployable baseline process. The PTT provides a notification of receipt of the baseline process optimization request, obtains a sub-process identification input, and resolves, via the processor, the unoptimized locally-deployable baseline process into one or more baseline sub-processes. Also, the PTT accesses a process template database for sub-process templates matching the resolved baseline sub-processes, and identifies, via the processor, sub-process templates matching the resolved baseline sub-processes using a matching procedure. The PTT modifies, via the processor, the identified sub-process templates according impact determinations generated using the matching procedure to generate custom globally optimized sub-processes, and stores the modified custom globally optimized sub-processes in a database.

### PRIORITY CLAIM

This application is a non-provisional of and claims priority under 35 USC §119 to: U.S. provisional patent application Ser. No. 61/537,806 filed Sep. 22, 2011, entitled “PROCESS TRANSFORMATION AND TRANSITIONING APPARATUSES, METHODS AND SYSTEMS,” attorney docket no. 20462-027PV. The entire contents of the aforementioned application are expressly incorporated by reference herein.

This patent application disclosure document (hereinafter “description” and/or “descriptions”) describes inventive aspects directed at various novel innovations (hereinafter “innovation,” “innovations,” and/or “innovation(s)”) and contains material that is subject to copyright, mask work, and/or other intellectual property protection. The respective owners of such intellectual property have no objection to the facsimile reproduction of the patent disclosure document by anyone as it appears in published Patent Office file/records, but otherwise reserve all rights.

### FIELD

The present inventions are directed generally to apparatuses, methods, and systems for global process optimization, and more particularly, to PROCESS TRANSFORMATION AND TRANSITIONING APPARATUSES, METHODS AND SYSTEMS (“PTT”).

### BACKGROUND

Various processes require use of numerous resources in their performance. Allocation of resources in an efficient manner is required to maximize the benefits obtained from such processes.

### BRIEF DESCRIPTION OF THE DRAWINGS

The accompanying appendices and/or drawings illustrate various non-limiting, example, inventive aspects in accordance with the present disclosure:

FIGS. 1A-C show block diagrams illustrating example aspects of process transformation and transitioning in some embodiments of the PTT;

FIGS. 2A-B show data flow diagrams illustrating an example global process optimization procedure in some embodiments of the PTT;

FIGS. 3A-B show logic flow diagrams illustrating example aspects of transforming a locally optimized baseline process into a custom globally optimized process in some embodiments of the PTT, e.g., an Optimized Process Transformation (“OPT”) component 300;

FIG. 4 shows a logic flow diagram illustrating example aspects of matching a locally optimized baseline process to a globally optimized sub-process template in some embodiments of the PTT, e.g., a Process Match Identification (“PMI”) component 400;

FIG. 5 shows a logic flow diagram illustrating example aspects of assessing the impact of transitioning from a locally optimized baseline process to a globally optimized process in some embodiments of the PTT, e.g., a Transition Impact Assessment (“TIA”) component 500;

FIG. 6 shows a data flow diagram illustrating an example optimized process utilization procedure in some embodiments of the PTT;

FIG. 7 shows a logic flow diagram illustrating example aspects of utilizing a custom globally optimized process in some embodiments of the PTT, e.g., an Optimized Process Utilization (“OPU”) component 700;

FIG. 8 shows an entity relationship data model illustrating example aspects of a Modification Contingency (“MC”) component 800;

FIG. 9 shows a block diagram illustrating embodiments of a PTT controller; and

Appendix A shows exemplary processes templates suitable for use in some embodiments of the PTT.

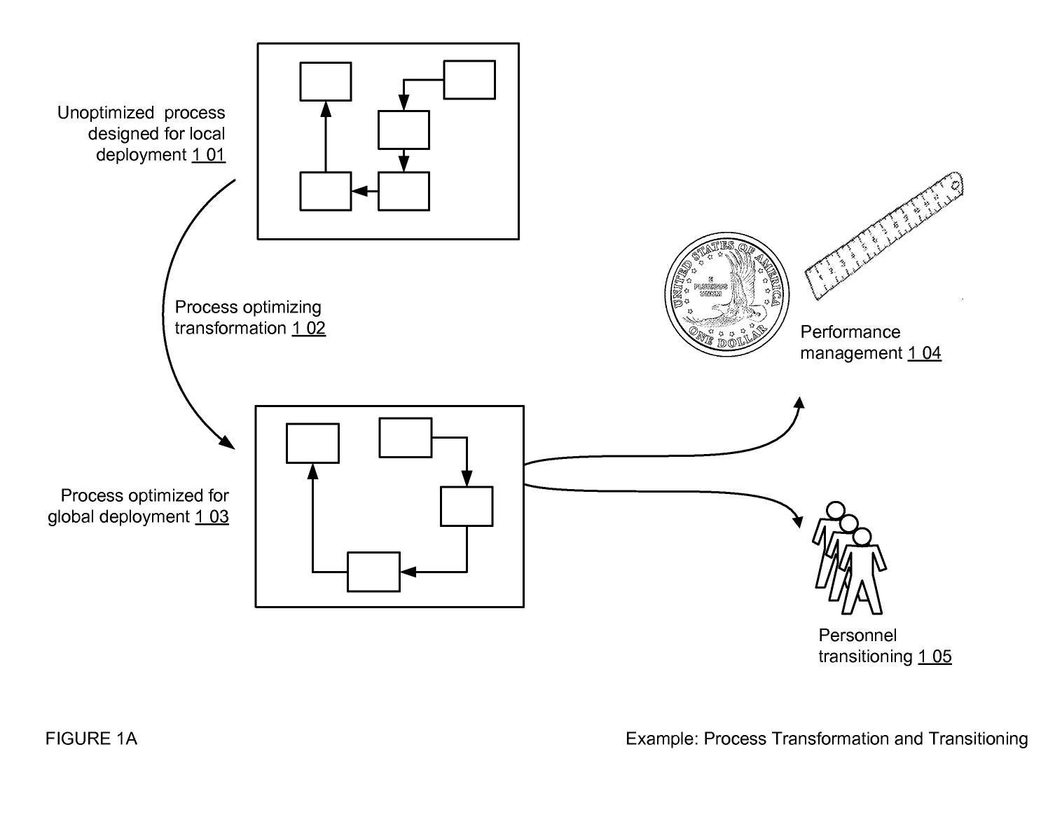

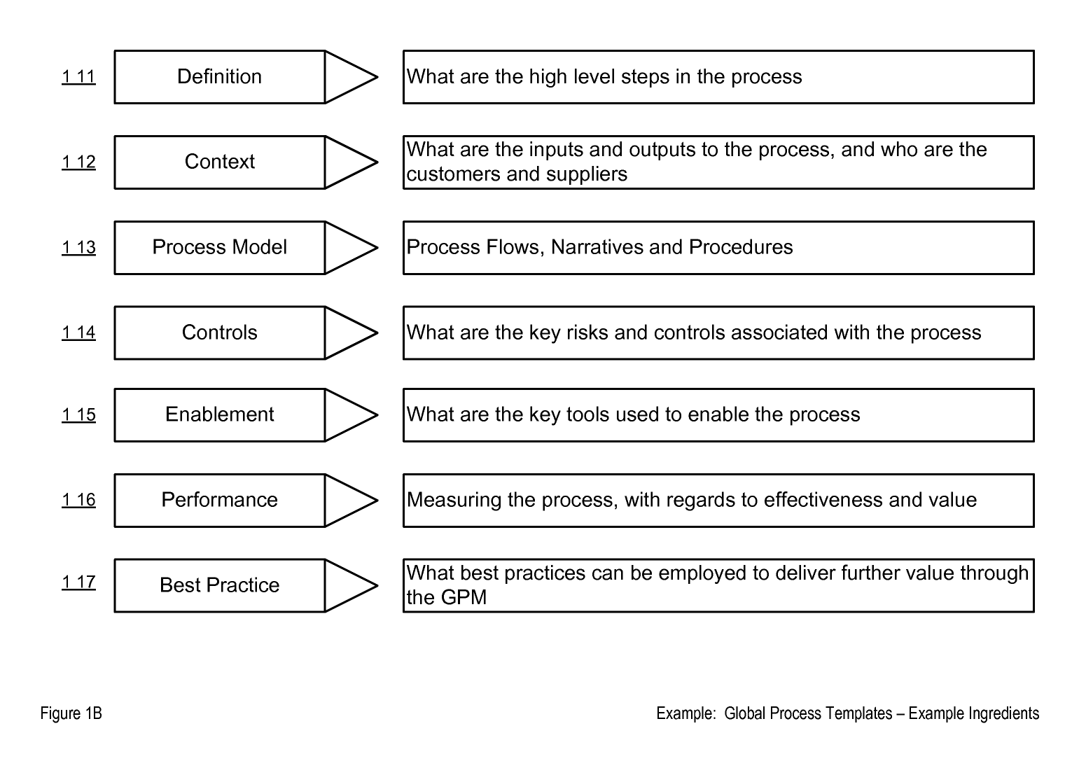

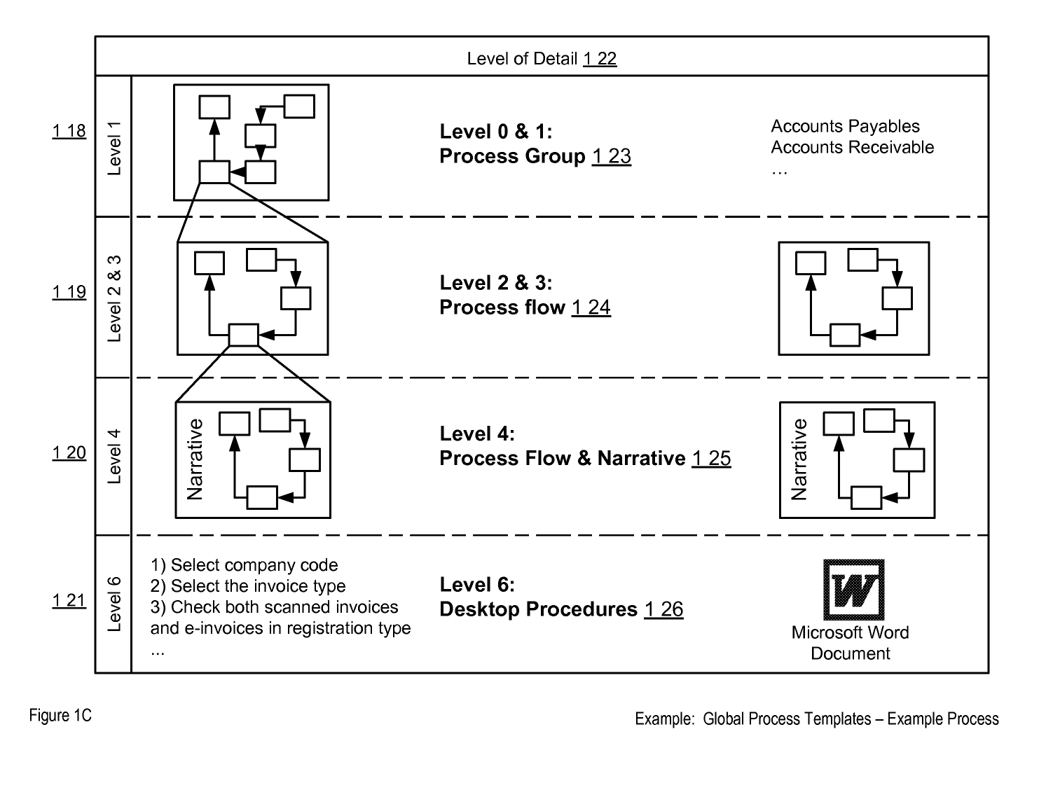

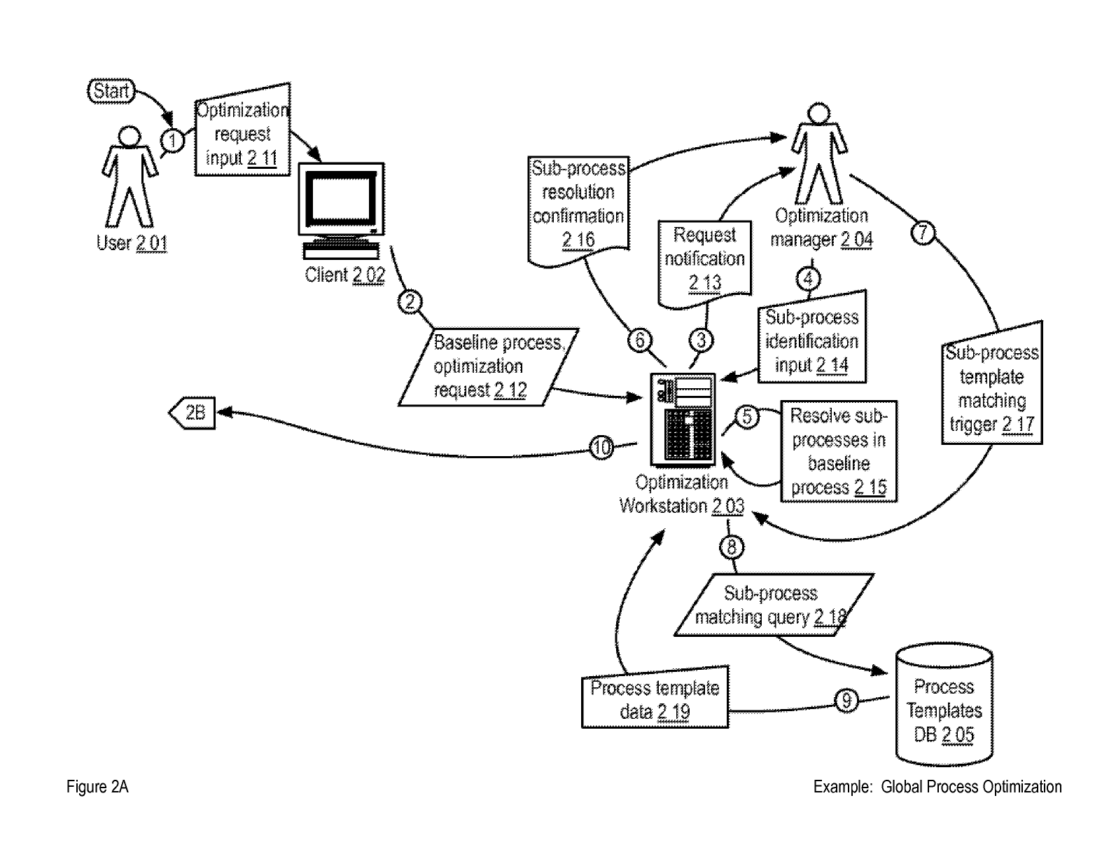

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### Process Transformation and Transitioning (PTT)

The PROCESS TRANSFORMATION AND TRANSITIONING APPARATUSES, METHODS AND SYSTEMS (hereinafter “PTT”) transform unoptimized locally-deployable baseline processes (hereinafter “UBP”), via PTT components, into custom globally optimized processes and transition materials (hereinafter “GOP”). FIGS. 1A-C show block diagrams illustrating example aspects of process transformation and transitioning in some embodiments of the PTT. With reference to FIG. 1A, in some implementations, the PTT may facilitate generation of process flows that may be deployed globally, and may also produce optimized results. For example, the PTT may obtain, as an input, an unoptimized process that is designed for local deployment, e.g., 101. The PTT may utilize a process optimizing transformation 102, and convert the locally deployable unoptimized process into a process that is optimized and suitable for global deployment, e.g., 103. In some implementations, the PTT, in the process of transforming the unoptimized locally-deployable process into the process optimized for global deployment, may also provide features to facilitate transitioning from the unoptimized locally-deployable process into the process optimized for global deployment. For example, the PTT may provide features to manage performance of actors implementing the process optimized for global deployment, e.g., 104. For example, the PTT may track key performance indicators (KPIs) associated with the performance attributes of the actors implementing the process optimized for global deployment. For example, such KPIs may include factors such as, but not limited to: time expended to complete a process, costs associated with the process, equipment/personnel usage associated with performance of the process, quality controls metrics associated with the process output, and/or the like. In general, any attribute of the process may be monitored against a KPI to manage performance of the actors implementing the process optimized for global deployment. Also, in some implementations, the PTT may provide features to facilitate transitioning, e.g., 105, the actors involved in implementing the process from the resources utilized to implement the unoptimized locally-deployed baseline process, to the resources utilized to implement the globally-optimized process. For example, such resources may include hardware equipment, computing power, software packages, personnel, skill sets of personnel, and/or the like. In some implementations, the PTT may provide notifications of resources that are to be modified to implement the globally-optimized process, as well as training resources to facilitate transition the actors from the unoptimized locally-deployable process to the process optimized for global deployment.

With reference to FIG. 1B, in some implementations, the PTT may optimize, transform and transition actors from one process (e.g., an unoptimized locally-deployable process) to another (e.g., an optimized globally-deployable process). In some implementations, a process may include a variety of elements, e.g., 111-117. For example, a process may include a definition of the sub-processes involved in the process, e.g., 111. Further, each process may include an indication of the context in which the process may normally be deployed, e.g., 112. In some implementations, the process may include a description of the sub-processes and flow of sub-processes included in the process, e.g., 113. Associated with each sub-process may be a narrative describing the sub-process. In some implementations, each process may include a set of controls utilized to manage the process and sub-processes, e.g., 114. The process may also include descriptions of resources, e.g., hardware, computing power, software packages, human resources, etc., utilized to perform the process, e.g., 115. In some implementations, key performance indicators and/or other metrics may be measured, and may be utilized in controlling the process flow, e.g., 116. Also, in some implementations, a set of best practices associated with each process may be included in the process, e.g., 117. Appendices A provides, inter alia, an example of such a process.

With reference to FIG. 1C, in some implementations, a process may be modular, e.g., it may be comprised of a number of sub-processes. For example, a process may have a high-level definition, e.g., 118, which may invoke lower level processes, e.g., 119. For example, processes at level 0 and level 1, e.g., 123, may define a category of processes (“process groups”), and may invoke processes at level 2 and 3, e.g., 124, defining process flows for a specific process within a process group. In some implementations, in turn, such lower-level processes may invoke processes that are at a still further lower level, e.g., 120. For example the process flow processes 124 may invoke sub-processes and their associated narratives 125. In some implementations, such narratives may invoke further granular details, such as details on specific desktop procedures, e.g., 121, 126, to be implemented as part of implementing the overall process.

FIGS. 2A-B show data flow diagrams illustrating an example global process optimization procedure in some embodiments of the PTT. With reference to FIG. 2A, in some implementations, a user 201 may desire to obtain a GOP as a replacement for a UBP. The user may utilize a client 202 to communicate with an optimization workstation 203 to obtain a GOP as a replacement for an UBP. For example, the user may provide an optimization request input 211 to the client. In various implementations, the optimization request input may include, but not be limited to: tap of a touchscreen interface, keyboard entry, mouse clicks, depressing buttons on a joystick/console, voice commands, single/multi-touch gestures on a touch-sensitive interface, touching user interface elements on a touch-sensitive display, provision of a data file, loading of an eXtensible Markup Language (“XML”) structured input file, provision of a text file, provision of a binary file, and/or the like.

In response, the client may generate a baseline process optimization request, and provide the baseline process optimization request, e.g., 212, to the optimization workstation. For example, the baseline process optimization request may include data such as, but not limited to: a contract for optimization services, a database file, a spreadsheet file, a graphics/presentation file (such as Omnigraffle, Visio, PowerPoint files, etc.), an eXtensible Markup Language (“XML”) encoded data file, etc., and may be communicated via fax, phone, telegram, electronic mail, postal mail, Internet file transfer, and/or the like. The optimization request may also, in some implementations, contain a description of the process that the user seeks to be converted from a UBP to a GOP. For example, the user may provide a (Secure) Hypertext Transfer Protocol (“HTTP(S)”) POST message including data formatted according to the eXtensible Markup Language (“XML”). In some embodiments, the baseline process optimization request 212 may be generated by the PTT using natural language processing as described herein, e.g. as described herein with respect to 310. An example baseline process optimization request 212, substantially in the form of a HTTP(S) POST message including XML-formatted data, is provided below:

POST /optimization_request.php HTTP/1.1
Host: www.merchant.com
Content-Type: Application/XML
Content-Length: 667
<?XML version = ”1.0” encoding = ”UTF-8”?>
<process_optimization_request>

<timestamp>2020-02-22 15:22:43</timestamp>
<user_details>

<user_name>JDoe@gmail.com</account_name>
<password>Tomcat123</password>

</user_details>
<baseline_process>

<client_process_id>12345<client_process_id>
<seq type=action priority=1 name=″receive_inv″>Receive invoice</seq>
<seq type=action priority=2 name=″pay_po″>Verify PO active</seq>
<seq type=control priority=3 name=″exception_amount″>

<if type=PO_greater_than value=35000>

<seq type=email_summary>comptroller@company.com</seq>

</if>
<else><seq type=null /></else>

</seq>
<seq type=action priority=4 name=″pay_inv″>Pay invoice</seq>

</baseline_process>

</process_optimization_request>

In some implementations, in response to receiving the baseline process optimization request, the optimization workstation may provide a request notification 213 to an optimization manager 204. In some embodiments, the optimization manager may be a server. The optimization manager may provide an input to trigger identification of sub-processes within the process 214 as part of servicing the baseline process optimization request. For example, the optimization manager may provide a sub-process identification input 214 such as, but not limited to: tap of a touchscreen interface, keyboard entry, mouse clicks, depressing buttons on a joystick/console, voice commands, single/multi-touch gestures on a touch-sensitive interface, touching user interface elements on a touch-sensitive display, and/or the like. For example, such input may provide triggers to the optimization workstation to resolve sub-processes in the baseline process, e.g., 215. In some embodiments, after resolving the sub-processes included in the baseline process, the optimization workstation may display a resolution confirmation 216 to the optimization manager 204. The optimization manager may then initiate a template matching trigger 217. Additional metadata about the sub-processes may be added by the optimization manager 204 as part of the sub-process template matching trigger 217, including keywords, identifiers and/or the like to assist the optimization workstation 203 in finding matching process templates 205. Upon resolving the sub-processes included in the baseline process, the optimization workstation may provide a sub-process matching query 218 to a process template database 205. For example, the optimization workstation may provide a query to the database to retrieve files including descriptions of processes matching the sub-processes resolved from the baseline process, e.g., 218. In some embodiments, the sub-process matching query may contain weighting factors that weight certain portions of a process more heavily in finding matching process templates. For example, a weighting factor may require that the first and last step in a sub-process matching query be present while allowing intermediate steps to be missing. In other embodiments, a numerical weighting value may be assigned to various parts of the sub-process matching query 218. In various implementations, the sub-process matching query 218 may include Structured Language Query (“SQL”) commands, memory read commands, and/or the like. An exemplary sub-process matching query 218, written substantially in the form of PHP/SQL commands, is provided below:

<?PHP
/*
Uses component parts of process to find candidate matching process
templates,

ranks based on closeness of matching.

*/
header(′Content-Type: text/plain′);
$matching_processes = array( );
mysql_connect(″201.408.185.132″,$DBserver,$password); // access
database server
mysql_select(″Process_Matching_DB.SQL″); // select database to
append
//step through process parts
for ($i=0; $i<$PROCESS_STEP_COUNT; $i++) {

$qu = mysql_query(”SELECT process_template_id,
process_description, * FROM
process_templates WHERE $PROCESS_TEMPLATE LIKE
process_descriptions″);
$res = mysql_query($qu);
$rows = mysql_num_rows($res);
//roll up matching processes into assembly var
for ($j=0; $j<$rows; $j++) {

$row = mysql_fetch_row($res);
$matching_processes[ ] = implode(″,″,$row);

}

}
//dedupe results - removes duplicate entries, ranks based on frequency
filter_unique_results_and_rank($matching_processes);
mysql_close(″CSF_DB.SQL″); // close connection to database
? >

In response to the sub-process matching query, the process templates database may provide the requested process template data 219. In some embodiments, the process template data may contain multiple matching templates including a matching score (i.e., 1-100 and/or the like). In other embodiments, the process template data 219 may contain meta-data about the processes. Meta-data may include a process identifier, a process name, the inputs required by a process, the outputs produced by a process, an indicator of which inputs and/or outputs may be optional or required by the process, a key performance indicator (“KPI”) value for the process, a matching score indicating how well the process template matches the sub-process matching query 218, and/or the like. In some embodiments, the score indicating how well the process template matches the sub-process matching query may be calculated substantially using a full text search matching algorithm (e.g., MySql LIKE and/or similar). In other embodiments, a table of keywords indicating similarity of terms may be stored in the process templates database and matches may be calculated based on similarity to those terms. In various implementations, the process template data may be encoded as a spreadsheet file, a graphics/presentation file (such as Omnigraffle, Visio, PowerPoint files, etc.), an eXtensible Markup Language (“XML”) encoded data file, etc., and may be communicated via a local memory read, fax, phone, telegram, electronic mail, postal mail, Internet file transfer, and/or the like. A process template data 219 response, substantially in the form of a HTTP(S) POST message including XML-formatted data, is provided below:

POST /authrequest.php HTTP/1.1
Host: www.merchant.com
Content-Type: Application/XML
Content-Length: 667
<?XML version = ”1.0” encoding = ”UTF-8”?>
<process_template_data>

<timestamp>2020-02-22 15:22:58</timestamp>
<candidate_processes>

<process id=5487 score=99>

<name>AP Enterprise v2</name>
<inputs>

<input id=632>Invoice number</input>
<input id=457>Purchase order number</input>
<input id=478>Client identifier</input>
<input id=457>PO history</input>

</inputs>
<outputs>

<output id=475>Invoice payment approval</output>

</outputs>
<kpi id=475>Speed of payment</kpi>
<kpi id=7845>Average touches per invoice</kpi>

</process>
<process id=4178 score=99>

<name>AP Enterprise v1.7</name>
<inputs>

<input id=632>Invoice number</input>
<input id=457>Purchase order number</input>
<input id=478>Client identifier</input>

</inputs>
<outputs>

<output id=475>Invoice payment approval</output>

</outputs>
<kpi id=475>Speed of payment</kpi>
<kpi id=789>Cash flow maintenance score</kpi>
<kpi id=7845>Average touches per invoice</kpi>

</process>

</candidate_processes>

</process_template_data>

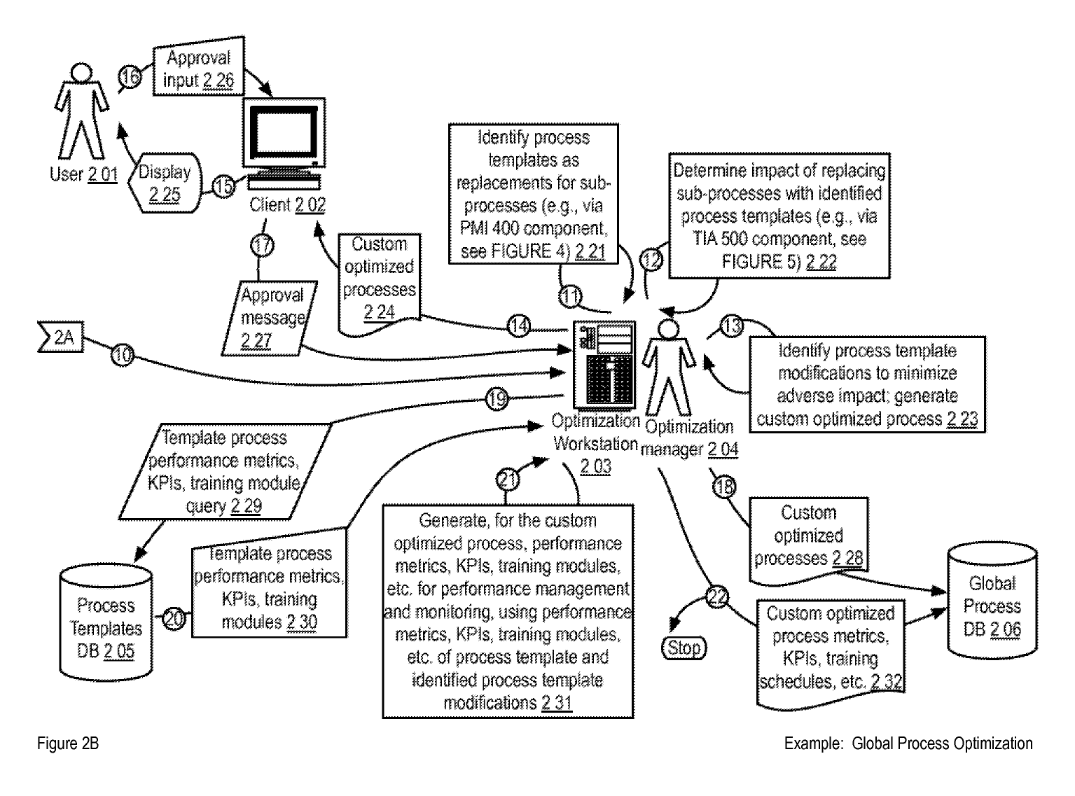

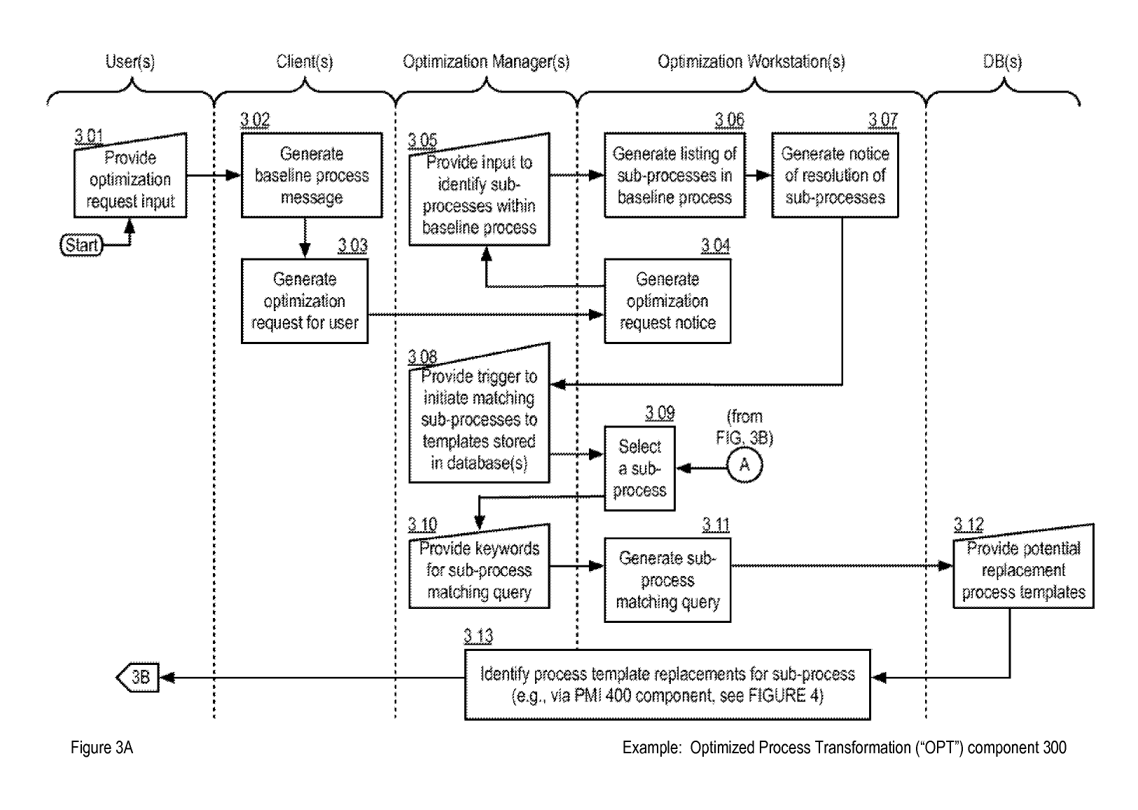

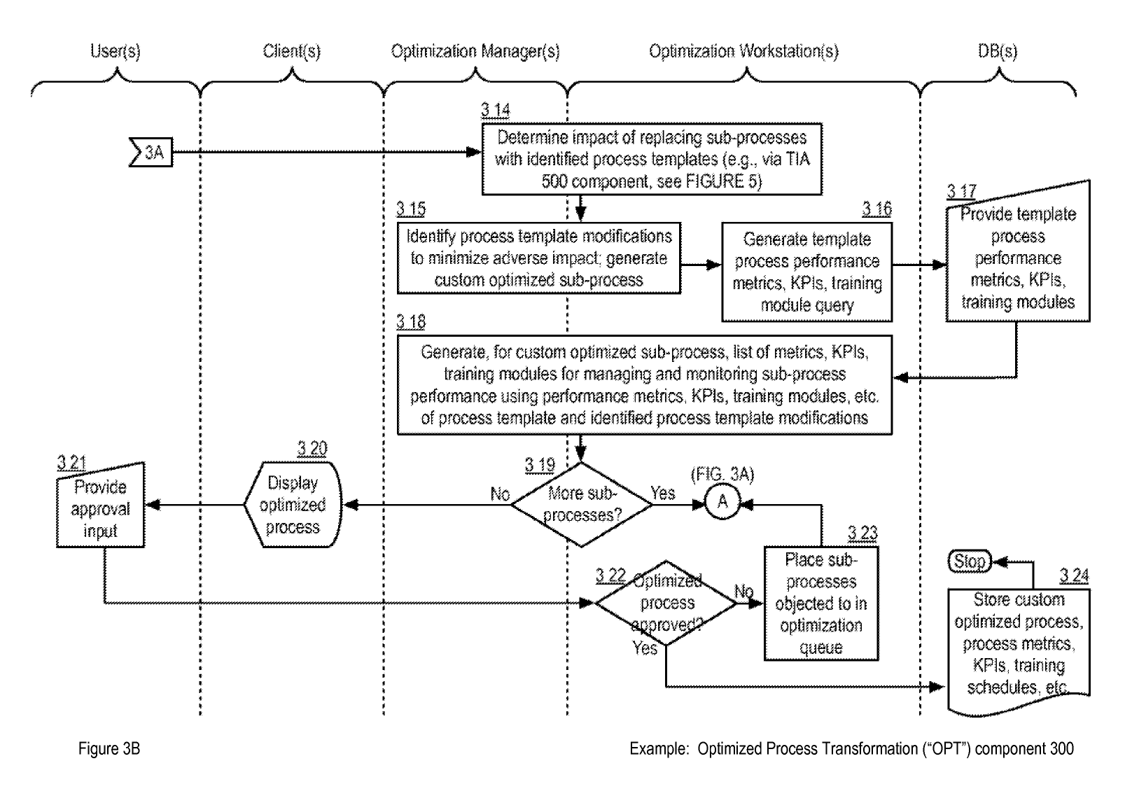

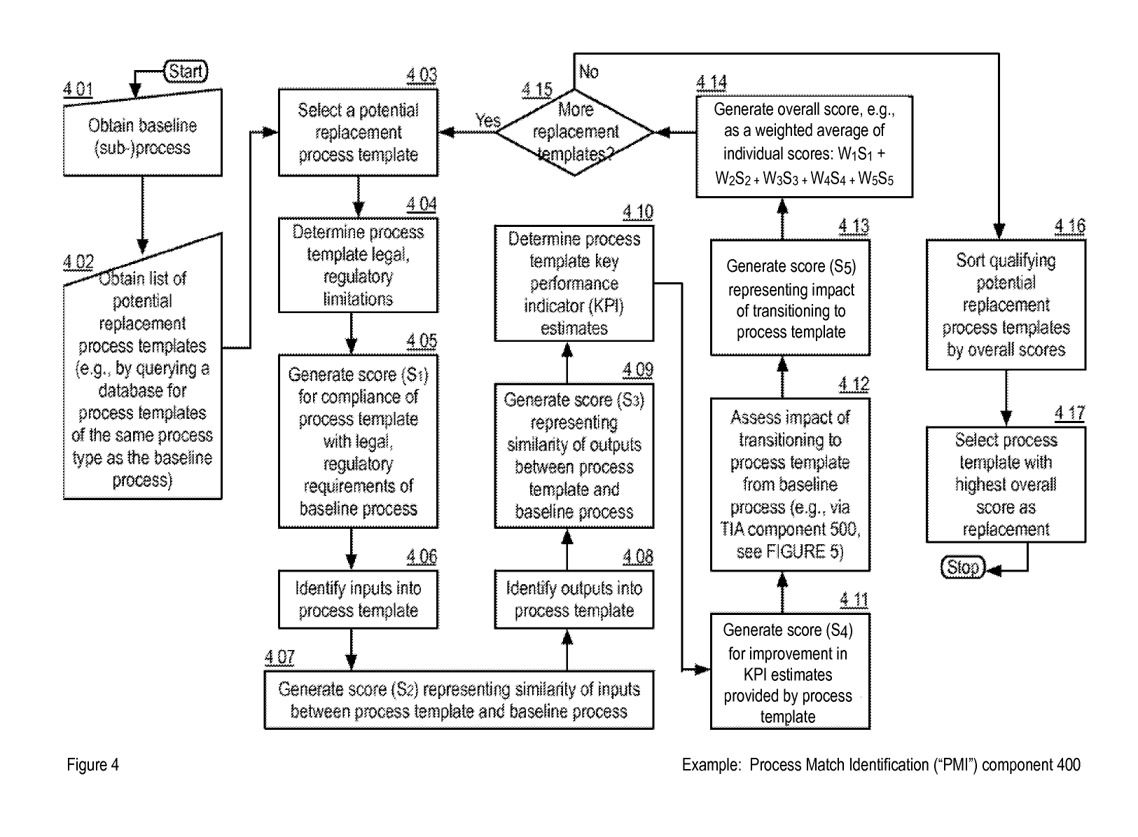

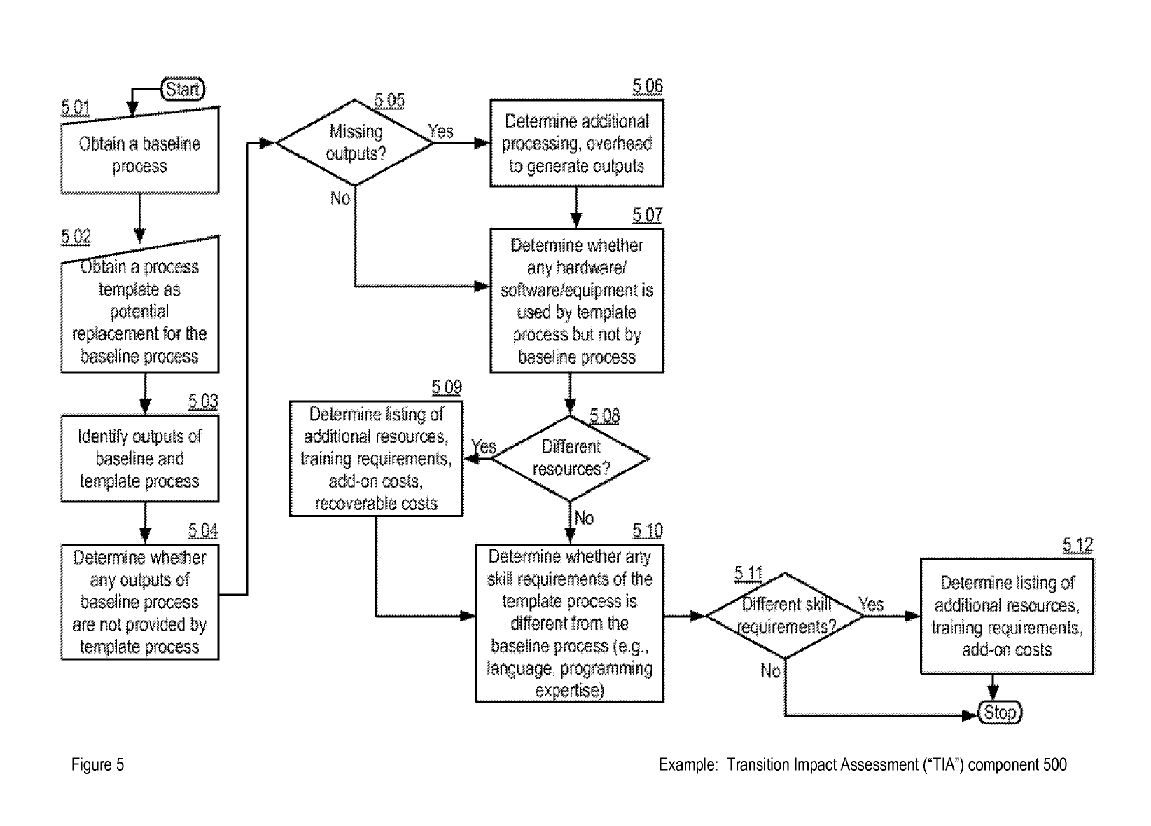

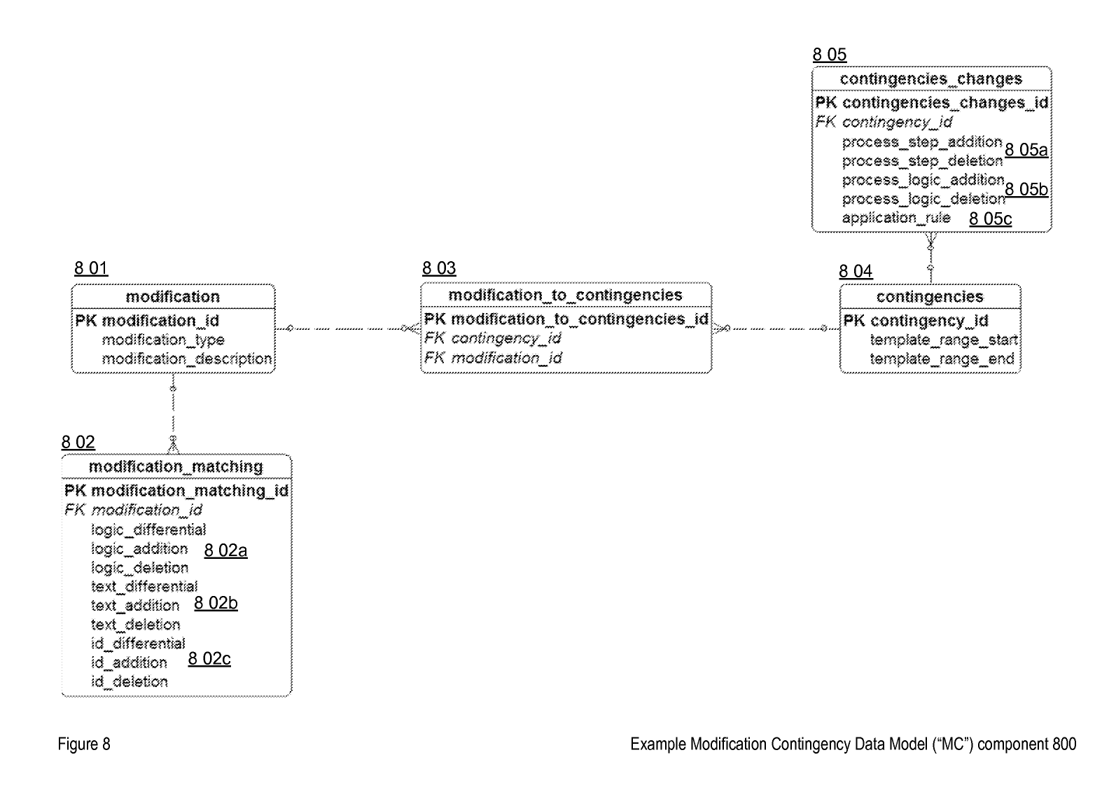

With reference to FIG. 2B, in some implementations, the PTT may utilize the process template data from the database and the baseline process from the client to identify process templates as replacements for the sub-processes resolved from the baseline process. For example, the PTT may obtain input from the optimization manager as part of identifying the replacement process templates for the sub-processes resolved from the baseline process, e.g., 221. In some implementations, the process manager may be a server. In some implementations, the PTT may utilize a procedure such as discussed below with reference to FIG. 4 to identify the replacement process templates. Upon identifying the replacement process templates, the PTT may determine the impact of replacing the sub-processes with the identified replacement process templates, e.g., 222. For example, the PTT may utilize a procedure such as described below with reference to FIG. 5 to perform the impact assessment. Using the impact assessment, the PTT may identify modifications to the standard replacement process templates to minimize any impact of the replacement 223, as measured by the impact assessment in 222. In some embodiments, the process template modifications to minimize the impact from replacing sub-processes with identified process templates 223 may include determining inputs and/or outputs in the process template not present in the replacement sub-process, or vice-versa. A modification contingency database may then be queried to determine appropriate modification to the process template to minimize the impact of replacing the sub-process with the process template. For an example embodiment of a modification contingency database, see FIG. 8 and related description below. For example, if the sub-process being replaced has multiple control points (e.g., logging, reporting, approval loops), while the process template only has one control point, the process template may be modified to include additional control points based on the potential impact of removing the control points. The modifications to the process template need not be commensurate in degree with the differential between the sub-process being replaced and the identified process template. For example, in some embodiments, some inputs may be weighted more heavily and require replacement and/or a corollary in the process template, while other inputs may be optional or given less weight. In other embodiments, a substantial differential in control points between a sub-process being replaced and a process template may have the adverse impact of replacement minimized with only one additional control point in the process template. Advantageously, this allows the PTT to modify process templates to minimize impact while retaining benefits of the sub-process replacement. In still other embodiments, the modification contingency database may contain a number of possible modifications to minimize the impact. For example, a sub-process financial payment control may not be present in the identified process template. The modification contingency database may have one modification option that introduces an additional control point at the beginning of the process, or an alternative modification that routes the financial payment to a more senior staff member. In doing so, multiple template modification strategies may be compared against one another. The PTT may, in some embodiments, generate a custom ranking score for the process template modifications based on the process template and the baseline process optimization request and choose the modification with the highest ranking score and the lowest impact.

The PTT may utilize the identified modifications to generate a custom, optimized, GOP as a replacement for the UBP provided by the user. The PTT may provide the GOP for the client, e.g., 224, for example in the form of a spreadsheet file, a graphics/presentation file (such as Omnigraffle, Visio, PowerPoint files, etc.), an eXtensible Markup Language (“XML”) encoded data file, etc., and communicated via fax, phone, telegram, electronic mail, postal mail, Internet file transfer, and/or the like. The client may in turn display, e.g., 225, the custom, optimized, and globally deployable process for the user. In some implementations, the user may provide an approval input to the client indicating approval of the custom, optimized, and globally deployable replacement process, e.g., 226. The client may generate and provide an approval message 227 to the optimization workstation in response to the user's approval input. In alternate implementations, the user and/or optimization manager may directly provide the approval input to the optimization workstation. Upon obtaining the approval message, the optimization workstation may store, e.g., 228, the approved custom, optimized, and globally deployable process in a database, e.g., global process database 206.

In some implementations, the optimization workstation may obtain template processes, performance metrics, KPIs, training modules, etc. from a process templates database, e.g., 229, for generating custom definitions, narratives, metrics, KPIs for the user-approved custom, optimized, and globally deployable process. The optimization workstation may generate, for the user-approved custom, optimized, and globally deployable process, performance metrics, KPIs, training modules, etc. for performance management and monitoring, e.g., 231, using the performance metrics, KPIs, training modules, etc. of the process templates and the identified process template modifications from 223. The optimization workstation may also store the custom optimized process metrics, KPIs, training modules, etc. in the global process database, e.g., 232, as part of the user-approved custom, optimized, and globally deployable process.

FIGS. 3A-B show logic flow diagrams illustrating example aspects of transforming a locally optimized baseline process into a custom globally optimized process in some embodiments of the PTT, e.g., an Optimized Process Transformation (“OPT”) component 300. With reference to FIG. 3A, in some implementations, a user may desire to obtain a custom optimized, globally-deployable process as a replacement for an unoptimized locally-deployable baseline process. The user may provide an optimization request input to a client 301. In response, the client may generate, e.g., 302, a baseline process message, and provide it as part of a baseline process optimization request for the user, e.g., 303, to the optimization workstation. For example, the baseline process optimization request may include data such as, but not limited to: a contract for optimization services, a database file, a spreadsheet file, a graphics/presentation file (such as Omnigraffle, Visio, PowerPoint files, etc.), an eXtensible Markup Language (“XML”) encoded data file, etc., and may be communicated via fax, phone, telegram, electronic mail, postal mail, Internet file transfer, and/or the like.

In some implementations, in response to receiving the baseline process optimization request, in some implementations, the optimization workstation may provide a request notification to an optimization manager 304. The optimization manager may provide an input to trigger identification of sub-processes within the process as part of servicing the baseline process optimization request, e.g., 305. For example, such input may provide triggers to the optimization workstation to resolve sub-processes in the baseline process, e.g., 306. Upon resolving the sub-processes included in the baseline process, the optimization workstation may generate a notice of resolution of the sub-processes in the baseline process, e.g., 307, to the optimization manager. The optimization manager may, in response, provide a trigger, e.g., 308, to initiate matching of the sub-processes in the baseline process to optimized globally-deployable, process templates stored in a process template database. In response, the optimization workstation may provide, for each sub-process in the baseline process (see e.g., 309), a sub-process matching query to a process template database, e.g., 311. For example, in some implementations, the optimization manager may provide keywords for generating the sub-process matching query, e.g., 310, for the optimization workstation to generate the sub-process matching query. In some embodiments, the query may use a natural language processing engine, and/or a natural language parsing framework, e.g., FreeLing, Rosette, Natural, Dragon Toolkit and/or the like. In other embodiments, the optimization manager may be a server. In some embodiments, the optimization manager may be pre-loaded with a repository of free-form process description documents. The documents may then be indexed using Optical Character Recognition (“OCR”) by the PTT for use in response to the sub-process matching query. Examples of OCR software suitable for this purpose include OpenOCR, JavaOCR (JOCR) and/or the like. Some embodiments of the PTT may use a combination of a repository of free-form process description documents and OCR to aid the matching of sub-processes to potential replacement process templates 312 without the optimization manager providing keyword input 310. In other embodiments, the sub-process matching query 311 may be generated and/or performed using an API for a publicly available Internet search engine such as Google, Bing and/or the like.

The optimization workstation may provide the query to a database to retrieve files including descriptions of processes matching the sub-processes resolved from the baseline process. In various implementations, the query may include Structured Language Query (“SQL”) commands, memory read commands, and/or the like. In response to the sub-process matching query, the process templates database may provide the requested process template data, e.g., 312. In various implementations, the process template data may be encoded as a spreadsheet file, a graphics/presentation file (such as Omnigraffle, Visio, PowerPoint files, etc.), an eXtensible Markup Language (“XML”) encoded data file, etc., and may be communicated via a local memory read, fax, phone, telegram, electronic mail, postal mail, Internet file transfer, and/or the like. The PTT may utilize the process template data from the database and the baseline process from the client to identify, e.g., 313, process templates as replacements for the sub-processes resolved from the baseline process, as described further below with reference to FIG. 4.

With reference to FIG. 3B, in some implementations, upon identifying the replacement process templates, the PTT may determine, e.g., 314, the impact of replacing the sub-processes with the identified replacement process templates. For example, the PTT may utilize a procedure such as described below with reference to FIG. 5 to perform the impact assessment. Using the impact assessment, the PTT may identify, e.g., 315, modifications to the standard replacement process templates to minimize any impact of the replacement, as measured by the impact assessment. The PTT may utilize the identified modifications to generate a custom, optimized, and globally deployable process as a replacement for the unoptimized locally-deployable baseline process provided by the user. In some implementations, the optimization workstation may obtain template processes, performance metrics, KPIs, training modules, etc. from a process templates database, e.g., 316-317, for generating custom definitions, narratives, metrics, KPIs for the user-approved custom, optimized, and globally deployable process. The optimization workstation may generate, e.g., 318, for the user-approved custom, optimized, and globally deployable process, performance metrics, KPIs, training modules, etc. for performance management and monitoring, using the performance metrics, KPIs, training modules, etc. of the process templates and the identified process template modifications. The optimization workstartion may perform the above procedure for each sub-process resolved from the baseline process provided by the client. Upon completion of the procedure for all the sub-process, e.g., 319, option “No,” the optimization may provide the custom, optimized, and globally deployable process for the client, for example in the form of a spreadsheet file, a graphics/presentation file (such as Omnigraffle, Visio, PowerPoint files, etc.), an eXtensible Markup Language (“XML”) encoded data file, etc., and communicated via fax, phone, telegram, electronic mail, postal mail, Internet file transfer, and/or the like. The client may in turn display, e.g., 320, the custom, optimized, and globally deployable process for the user. In some implementations, the user may provide an approval input to the client indicating approval of the custom, optimized, and globally deployable replacement process, e.g., 321. The client may generate and provide an approval message to the optimization workstation in response to the user's approval input. In alternate implementations, the user and/or optimization manager may directly provide the approval input to the optimization workstation. If approval is not obtained for one or more sub-processes (see e.g., 322, option “No”), the optimization workstation may place the sub-processes that were disapprove in a queue for re-optimization, e.g., 323, and process the sub-processes again according to the above-described procedure. Upon obtaining the approval message for all resolved sub-processes (see e.g., 322, option “Yes”), the optimization workstation may store, e.g., 324, the approved custom, optimized, and globally deployable process in a database. The optimization workstation may also store the custom optimized process metrics, KPIs, training modules, etc. in the global process database as part of the user-approved custom, optimized, and globally deployable process.

FIG. 4 shows a logic flow diagram illustrating example aspects of matching a locally optimized baseline process to a globally optimized sub-process template in some embodiments of the PTT, e.g., a Process Match Identification (“PMI”) component 400. In some implementations, the PTT may utilize a variety of factors to identify a replacement process template for a sub-process resolved from an unoptimized locally-deployable baseline process. For example, the PTT may obtain a baseline (sub-) process (“baseline process”), e.g., 401, for which to obtain a replacement optimized, globally-deployable process template. The PTT may obtain a list of potential replacement process templates, e.g., by querying a database for a list of all process templates within a process group that matches the process group identification of the baseline process, e.g., 402. The PTT may select, e.g., 403, one of the potential replacement process templates, and generate a score for that potential replacement process template. For example, the PTT may determine legal, compliance and/or regulatory limitations for the process template, e.g., 404. In some embodiments, examples of legal, compliance and/or regulatory limitations may include the compliance of the procedure with an Act of Congress, a financial regulation (e.g., Sarbanes-Oxley), compliance with a corporate environmental initiative, compliance with Occupational Safety and Health Administration workplace requirements and/or the like. The PTT may compare the limitations of the process template to those of the baseline process, and generate a score (say S₁) reflecting the compliance of the process template with the legal, regulatory, etc. requirements of the baseline process, e.g., 405. In some embodiments of the PTT, the compliance of the process template may be calculated with a weighted score that considers the probability of a legal, compliance and/or regulatory limitation being enforced, a score that represents the business value of compliance, and/or the like. The PTT may identify inputs provided for the process template, e.g., 406, and compare the inputs of the process template to those of the baseline process. Based on the comparison, the PTT may generate a score (say S₂) representing the similarity of inputs between the process template and the baseline process, e.g., 407. In some implementations, the PTT may identify outputs provided by the process template, e.g., 408, and compare the outputs of the process template to those of the baseline process. Based on the comparison, the PTT may generate a score (say S₃) representing the similarity of outputs between the process template and the baseline process, e.g., 409. The PTT may determine process template key performance indicator (KPIs) estimates, e.g., 410, and compare the KPI estimates of the process template to those of the baseline process. Based on the comparison, the PTT may generate a score (say S₄) representing the improvement of KPI estimates provided by the process template over the baseline process, e.g., 411. Also, in some implementations, the PTT may assess the impact of transitioning to the process template from the baseline process, e.g., 412, for example using a procedure as described further below with reference to FIG. 5. The PTT may generate a score (say S₅) representing the impact of transitioning from the baseline process to the potential replacement process template, e.g., 413. The PTT may generate an overall weighted score by calculating a weighted average of the individual scores, e.g., 414. In some implementations, the PTT may perform such a weighted score calculation for each of the process templates that may be potential replacement for the baseline process, see 415. The PTT may then sort the potential replacement process templates according to their scores, e.g., 416, and select the process template with the highest overall score as the replacement process template for the baseline process, e.g., 417.

FIG. 5 shows a logic flow diagram illustrating example aspects of assessing the impact of transitioning from a locally optimized baseline process to a globally optimized process in some embodiments of the PTT, e.g., a Transition Impact Assessment (“TIA”) component 500. In some implementations, the PTT may generate an impact assessment as part of selecting a potential replacement process template for a baseline process, or may utilize an impact assessment to modify a replacement process template to generate a custom, optimized, globally-deployable process for a user. The PTT may obtain a base line process, e.g., 501, and obtain a process template selected as a replacement for the baseline process, e.g., 502. The PTT may identify the outputs of the baseline and template processes, e.g., 503, and determine whether any of the outputs of the baseline process are not provided by the replacement process template, e.g., 504. If there are any missing outputs, e.g., 505, option “Yes,” the PTT may determine additional processes, processing overhead, costs, etc. to generate the missing outputs, e.g., 506. The PTT may determine whether any hardware/software/equipment is used by the replacement template process (or modification thereof), but not by the baseline process, e.g., 507. If there are different resources utilized, e.g., 508, option “Yes,” the PTT may generate a listing of additional resources, training requirements, add-on costs, etc. due to the utilization of different resources 509. The PTT may also determine if any of the resources/costs are recoverable due to the freeing up of resources that the baseline process utilizes, but the replacement process does not utilize. In some implementations, the PTT may determine, e.g. 510, whether any skill requirements of the replacement process templates are different from the baseline process (e.g., spoken language, programming expertise, marketing skills, etc.). If any skills required are different, e.g., 511, option “Yes,” the PTT may generate, e.g., 512, a listing of additional resources, training requirements, add-on costs, etc. associated with supplying the additional skills called for by the replacement process template. In some embodiments of the PTT, the impact assessment may be substantially in the form of a formula. An example of a formula for impact assessment is: (Weighting Factor CI)*Change In Inputs+(Weighting Factor CO)*Change in Outputs+(Weighting Factor CR)*Change in Resources Required+(Weighting Factor SR)*Change in Skill Requirements. In some embodiments of the PTT, the formula may contain weighting factors, e.g., CI, CO, CR, SR, and/or the like, which are set by the administrator of the PTT.

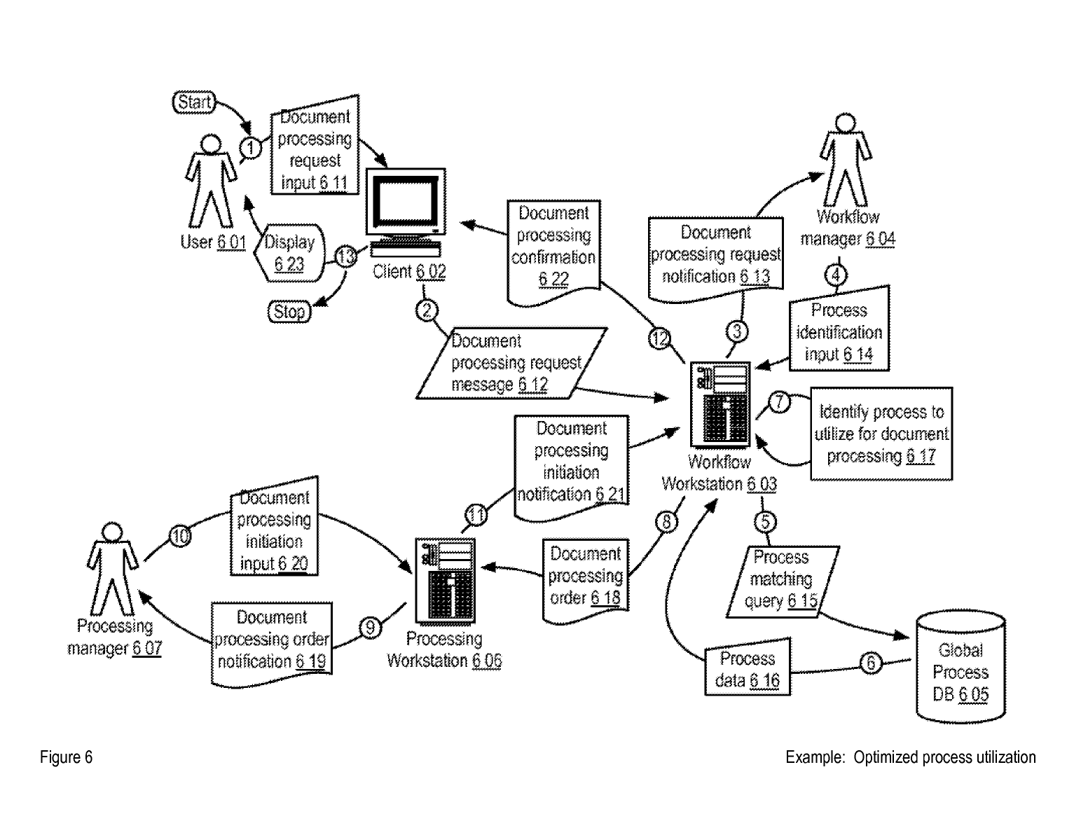

FIG. 6 shows a data flow diagram illustrating an example optimized process utilization procedure in some embodiments of the PTT. In some implementations, the PTT may utilize a custom, optimized, globally-deployable process for processing a service request from the user. In some implementations, a user 601 may provide, e.g., 611, a document processing request input to a client 602 to trigger utilization of a custom, optimized, globally-deployable process for processing a service request from the user. For example, in various implementations, the user may provide input to a client such as, but not limited to: tap of a touchscreen interface, keyboard entry, mouse clicks, depressing buttons on a joystick/console, voice commands, single/multi-touch gestures on a touch-sensitive interface, touching user interface elements on a touch-sensitive display, and/or the like. Upon obtaining the document processing request input, the client may generate and provide a document processing request message, e.g., 612, to a workflow workstation 603. In various implementations, the document processing request message may include a contract (e.g., a service level agreement), a spreadsheet file, a graphics/presentation file (such as Omnigraffle, Visio, PowerPoint files, etc.), an eXtensible Markup Language (“XML”) encoded data file, etc., and may be communicated via a local memory read, fax, phone, telegram, electronic mail, postal mail, Internet file transfer, and/or the like.

The workflow workstation may provide a document processing request notification 613 to a workflow manager, e.g., 604. The workflow manager may provide a process identification input, e.g., 614, to the workflow workstation. Using the process identification input, the workflow workstation may identify, e.g., 617, a custom, optimized and globally deployable process to utilize for processing the incoming document. For example, the workflow workstation may provide a process matching query, e.g., 615, to a process templates database 605. In response, the global process database may provide the custom, optimized, globally deployable process data according to which the incoming document from the user should be processed 616. The workflow workstation may provide a document processing order, e.g. 618, to a processing workstation 606, including details on the incoming document as well as the global process according to which the incoming document should be processed. The processing workstation may provide a notification, e.g., 619 to a processing manager 607 indicating receipt of a document processing order. In response, the processing manager may provide a document processing initiation input, e.g., 620, indicating initiation of processing of the incoming document according to the global process 621. In some implementations, the workflow workstation may provide, e.g., 622, a document processing confirmation to the client, which may in turn display, e.g., 623, the confirmation to the user.

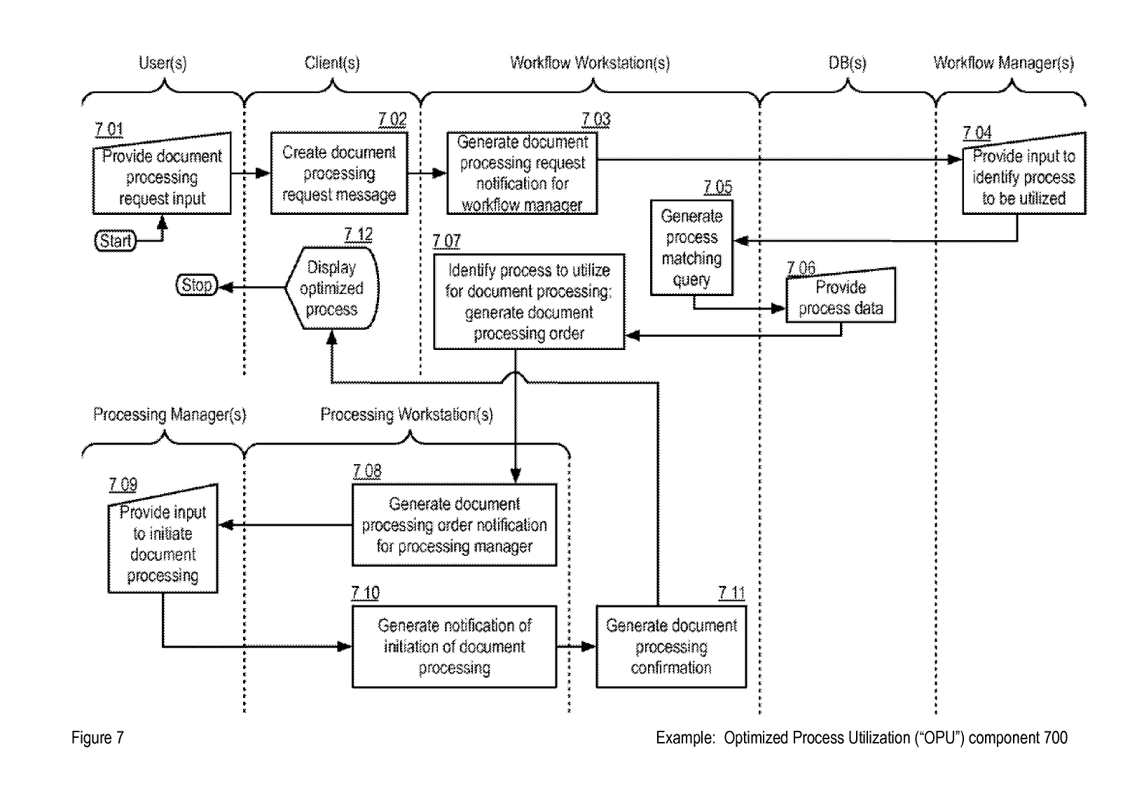

FIG. 7 shows a logic flow diagram illustrating example aspects of utilizing a custom globally optimized process in some embodiments of the PTT, e.g., an Optimized Process Utilization (“OPU”) component 700. In some implementations, the PTT may utilize a custom, optimized, globally-deployable process for processing a service request from the user. In some implementations, a user may provide, e.g., 701, a document processing request input to a client to trigger utilization of a custom, optimized, globally-deployable process for processing a service request from the user. Upon obtaining the document processing request input, the client may generate and provide a document processing request message, e.g., 702, to a workflow workstation. In various implementations, the document processing request message may include a contract (e.g., a service level agreement), a spreadsheet file, a graphics/presentation file (such as Omnigraffle, Visio, PowerPoint files, etc.), an eXtensible Markup Language (“XML”) encoded data file, etc., and may be communicated via a local memory read, fax, phone, telegram, electronic mail, postal mail, Internet file transfer, and/or the like.

The workflow workstation may provide a document processing request notification to a workflow manager, e.g., 703. The workflow manager may provide a process identification input, e.g., 704, to the workflow workstation. Using the process identification input, the workflow workstation may identify, e.g., 707, a custom, optimized and globally deployable process to utilize for processing the incoming document. For example, the workflow workstation may provide a process matching query, e.g., 705, to a process templates database. In response, the global process database may provide, e.g., 706, the custom, optimized, globally deployable process data according to which the incoming document from the user should be processed. The workflow workstation may provide a document processing order, e.g. 707, to a processing workstation, including details on the incoming document as well as the global process according to which the incoming document should be processed. The processing workstation may provide a notification, e.g., 708, to a processing manager 607 indicating receipt of a document processing order. In response, the processing manager may provide a document processing initiation input, e.g., 709, indicating initiation of processing of the incoming document, e.g., 710, according to the global process. In some implementations, the workflow workstation may provide, e.g., 711, a document processing confirmation to the client, which may in turn display, e.g., 712, the confirmation to the user.

FIG. 8 illustrates an example modification contingency database, substantially in the form of a data model. In some embodiments of the PTT, the modification database can be created using SQL commands substantially in the form of:

CREATE TABLE ‘modification‘ (‘modification_id‘ INTEGER NOT NULL,

‘modification_type‘ VARCHAR(40) COMMENT ′Type of modification′,
‘modification_description‘ TEXT COMMENT ′Free-form description of

the modification.′,

CONSTRAINT ‘PK_modification‘ PRIMARY KEY (‘modification_id‘)

)
CREATE TABLE ‘modification_matching‘ (

‘modification_matching_id‘ INTEGER NOT NULL,
‘modification_id‘ INTEGER,
‘logic_differential‘ TEXT,
‘logic_addition‘ TEXT,
‘logic_deletion‘ TEXT,
‘text_differential‘ TEXT,
‘text_addition‘ TEXT,
‘text_deletion‘ TEXT,
‘id_differential‘ VARCHAR(40),
‘id_addition‘ VARCHAR(40),
‘id_deletion‘ VARCHAR(40),
CONSTRAINT ‘PK_modification_matching‘ PRIMARY KEY

(‘modification_matching_id’)
);
CREATE TABLE ‘contingencies‘ (

‘contingency_id‘ INTEGER NOT NULL,
‘template_range_start‘ VARCHAR(40),
‘template_range_end‘ VARCHAR(40),
CONSTRAINT ‘PK_contingencies‘ PRIMARY KEY (‘contingency_id‘)

);
CREATE TABLE ‘modification_to_contingencies‘ (

‘modification_to_contingencies_id‘ VARCHAR(40) NOT NULL,
‘contingency_id‘ INTEGER,
‘modification_id‘ INTEGER,
CONSTRAINT ‘PK_modification_to_contingencies‘ PRIMARY KEY

(‘modification_to_contingencies_id‘)
);
CREATE TABLE ‘contingencies_changes‘ (

‘contingencies_changes_id‘ INTEGER NOT NULL,
‘contingency_id‘ INTEGER,
‘process_step_addition‘ TEXT,
‘process_step_deletion‘ TEXT,
‘process_logic_addition‘ TEXT,
‘process_logic_deletion‘ TEXT,
‘application_rule‘ TEXT,
CONSTRAINT ‘PK_contingencies_modifications‘ PRIMARY KEY

(‘contingencies_modification_id‘)
)
ALTER TABLE ‘modification_matching‘ ADD CONSTRAINT
‘modification_modification_matching‘

FOREIGN KEY (‘modification_id‘) REFERENCES ‘modification‘

(‘modification_id‘);
ALTER TABLE ‘modification_to_contingencies‘ ADD CONSTRAINT
‘contingencies_modification_to_contingencies’

FOREIGN KEY (‘contingency_id‘) REFERENCES ‘contingencies‘

(‘contingency_id‘);
ALTER TABLE ‘modification_to_contingencies‘ ADD CONSTRAINT
‘modification_modification_to_contingencies‘

FOREIGN KEY (‘modification_id‘) REFERENCES ‘modification‘

(‘modification_id‘);
ALTER TABLE ‘contingencies_changes‘ ADD CONSTRAINT
‘contingencies_contingencies_changes‘
FOREIGN KEY (‘contingency_id‘) REFERENCES ‘contingencies‘
(‘contingency_id‘);

In some embodiments of the PTT, a modification contingency database may be used to store contingent modifications to be used on process templates to minimize the adverse impact of a change from a UBP to a GOP. Example impacts that may be minimized include business profitability decreases, management approval and/or buy-in, regulatory process requirements, and/or the like. In other embodiments, impacts may seek to be optimized and/or maximized. In doing so, benefits of the process transformation may be preserved while simultaneously realizing benefit from the use of a modified process template.

The modification contingency database may, in some embodiments, contain a list of modifications 801. Modifications may represent the differential between a UBP and a candidate or selected process template. In some embodiments, the modification contingency database may contain modifications 801 that represent the difference between a sub-process 215 and a process template, e.g., 205, 219. The modifications may contain a type representing a category of the modification. Some example modification categories include, “reduction in financial oversight,” “reduced approval oversight,” “increased speed of processing,” and/or the like. A user of the PTT may specify the modification types that are most appropriate for their business, or a default list may be used similar to that discussed above.

In order to assist the PTT in the matching of modifications to sub-processes and/or UBP differentials, the modification contingency database may contain a modification matching capability 802. A PTT administrator or user may define any number of matching rules 802 to correspond to any single modification 801. In doing so, complex and multidimensional rules based on multiple criteria may be built for a single modification. Rules may be based on a difference in logic between the UBP and a process template e.g., 205, 219, and/or a difference in logic between a sub-process 215 and a process template. The difference in logic may be expressed either in the form of a differential (representing only the difference), an addition (representing only the added logic), a deletion (representing only the deleted logic), and/or the like. An example differential in logic 802a, substantially in the form of XML is as follows:

<?XML version = ”1.0” encoding = ”UTF-8”?>
<logic_differential>

<seq id=1>

<remove type=″approval_loop″ desc=″Approval loop
removed″>
<add type=″log_to_history″ desc=″History logging added″>

</seq>

</logic_differential>

Similar data structures may be stored in the logic_addition and logic_deletion fields of the modification contingency database. In some embodiments, matching rules may be based on the differential, addition, and/or deletion of text, e.g. 802b. Matching rules based on text may allow matching based on any textual description associated with the UBP, GOP, sub-process, process template and/or the like. In some embodiments, the PTT may allow matching based on the differential, addition, and/or deletion of a particular identifier (such as a process step identifier or other similar identifier suitable for representing the piece of a process being matched in the differential, addition and/or deletion), e.g., 802c. Identifier matching rules 802c may be used to allow matching based on any identifier (numerical, textual, and/or the like) associated with a UBP, GOP, sub-process, process template and/or the like.

In some embodiments, the modification contingency database may contain contingencies 804. Contingencies represent process components, process steps, logic and/or the like that may be added and/or removed from a process to minimize the adverse impact of a difference between a UBP and a process template e.g., 205, 219, and/or between a sub-process 215 and a process template. In some embodiments, particular contingencies 804 are associated with particular modifications 801 through the use of a join table, e.g., 803. The join table 803 may contain a primary key and foreign keys associated with the tables being joined, e.g., 801 and 804. Contingencies may only apply to, or only be suitable for, application to certain process templates. In some embodiments, the contingencies table 804 may contain fields that allow a range, or multiple ranges, of templates to be specified. In doing so contingencies may be mapped not only to modifications but also to ranges of process templates.

Contingencies 804 may be associated with one or more contingency changes 805. Contingency changes are changes to a process template that may be made to minimize the adverse impact discussed above. In some embodiments, a single contingency 804 record may be associated with multiple contingency changes 805. In doing so, complex sets of changes may be instituted to minimize an adverse impact. Contingency changes 805 may include additions and/or deletions, e.g., 805a, to the process template. In some embodiments, a step is a discrete part of a process. Additionally, logic changes may be stored in the contingency changes table 805 for use in customizing a process template to minimize an adverse impact. Logic additions and/or logic deletions 805b may be represented, in some embodiments, as XML substantially similar to 802a described above. In doing so, the PTT may allow an administrator to use a common language to describe logic to match a process as well as logic to modify a process. Contingency changes 805 may also, in some embodiments, contain application rules 805c. Application rules define conditions within the PTT whereby, in some embodiments, the contingency changes are selectively applied even when a modification 801 is made that matches a modification to matching rule 802 and has a mapping to a contingency, e.g. 803. Application rules 805c may be substantially in the form of program instructions including Java, PHP, and/or the like and may define conditions in which the contingency change 805 is applied. In doing so, a contingency 804 may have multiple matching contingency changes 805 which may be selectively applied to modifications based on conditions within or external to the PTT. Example conditions that may be triggered and/or handled by an application rule 805c include global financial market index values, business analytics software output, UBP and/or GOP attributes, and/or the like.

### PTT Controller

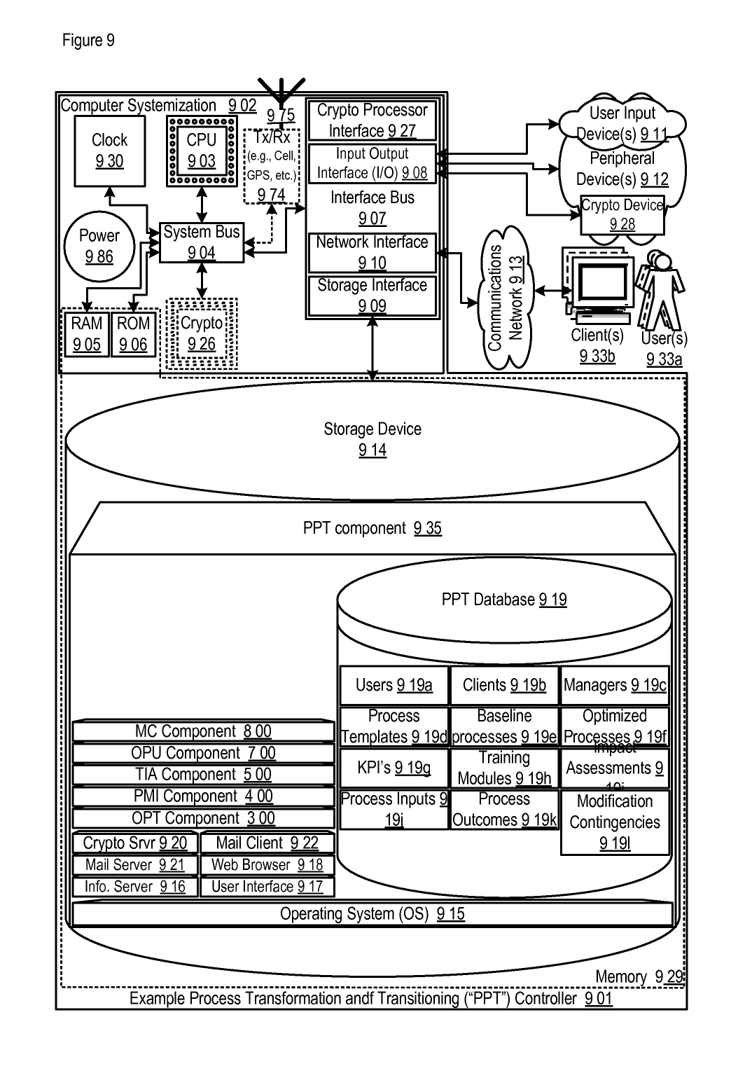

FIG. 9 illustrates inventive aspects of a PTT controller 901 in a block diagram. In this embodiment, the PTT controller 901 may serve to aggregate, process, store, search, serve, identify, instruct, generate, match, and/or facilitate interactions with a computer through various technologies, and/or other related data.

Typically, users, e.g., 933a, which may be people and/or other systems, may engage information technology systems (e.g., computers) to facilitate information processing. In turn, computers employ processors to process information; such processors 903 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 929 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the PTT controller 901 may be connected to and/or communicate with entities such as, but not limited to: one or more users from user input devices 911; peripheral devices 912; an optional cryptographic processor device 928; and/or a communications network 913. For example, the PTT controller 901 may be connected to and/or communicate with users, e.g., 933a, operating client device(s), e.g., 933b, including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The PTT controller 901 may be based on computer systems that may comprise, but are not limited to, components such as: a computer systemization 902 connected to memory 929.

### Computer Systemization

A computer systemization 902 may comprise a clock 930, central processing unit (“CPU(s)” and/or “processor(s)” (these terms are used interchangeable throughout the disclosure unless noted to the contrary)) 903, a memory 929 (e.g., a read only memory (ROM) 906, a random access memory (RAM) 905, etc.), and/or an interface bus 907, and most frequently, although not necessarily, are all interconnected and/or communicating through a system bus 904 on one or more (mother)board(s) 902 having conductive and/or otherwise transportive circuit pathways through which instructions (e.g., binary encoded signals) may travel to effect communications, operations, storage, etc. Optionally, the computer systemization may be connected to an internal power source 986; e.g., optionally the power source may be internal. Optionally, a cryptographic processor 926 and/or transceivers (e.g., ICs) 974 may be connected to the system bus. In another embodiment, the cryptographic processor and/or transceivers may be connected as either internal and/or external peripheral devices 912 via the interface bus I/O. In turn, the transceivers may be connected to antenna(s) 975, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing PTT controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 929 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the PTT controller and beyond through various interfaces. Should processing requirements dictate a greater amount speed and/or capacity, distributed processors (e.g., Distributed PTT), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the PTT may be achieved by implementing a microcontroller such as CAST's R8051XC2 microcontroller; Intel's MCS 51 (i.e., 8051 microcontroller); and/or the like. Also, to implement certain features of the PTT, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the PTT component collection (distributed or otherwise) and/or features may be implemented via the microprocessor and/or via embedded components; e.g., via ASIC, coprocessor, DSP, FPGA, and/or the like. Alternately, some implementations of the PTT may be implemented with embedded components that are configured and used to achieve a variety of features or signal processing.

Depending on the particular implementation, the embedded components may include software solutions, hardware solutions, and/or some combination of both hardware/software solutions. For example, PTT features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the PTT features. A hierarchy of programmable interconnects allow logic blocks to be interconnected as needed by the PTT system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the PTT may be developed on regular FPGAs and then migrated into a fixed version that more resembles ASIC implementations. Alternate or coordinating implementations may migrate PTT controller features to a final ASIC instead of or in addition to FPGAs. Depending on the implementation all of the aforementioned embedded components and microprocessors may be considered the “CPU” and/or “processor” for the PTT.

### Power Source

The power source 986 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 986 is connected to at least one of the interconnected subsequent components of the PTT thereby providing an electric current to all subsequent components. In one example, the power source 986 is connected to the system bus component 904. In an alternative embodiment, an outside power source 986 is provided through a connection across the I/O 908 interface. For example, a USB and/or IEEE 1394 connection carries both data and power across the connection and is therefore a suitable source of power.

### Interface Adapters

Interface bus(ses) 907 may accept, connect, and/or communicate to a number of interface adapters, conventionally although not necessarily in the form of adapter cards, such as but not limited to: input output interfaces (I/O) 908, storage interfaces 909, network interfaces 910, and/or the like. Optionally, cryptographic processor interfaces 927 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 909 may accept, communicate, and/or connect to a number of storage devices such as, but not limited to: storage devices 914, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 910 may accept, communicate, and/or connect to a communications network 913. Through a communications network 913, the PTT controller is accessible through remote clients 933b (e.g., computers with web browsers) by users 933a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed PTT), architectures may similarly be employed to pool, load balance, and/or otherwise increase the communicative bandwidth required by the PTT controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 910 may be used to engage with various communications network types 913. For example, multiple network interfaces may be employed to allow for the communication over broadcast, multicast, and/or unicast networks.

Input Output interfaces (I/O) 908 may accept, communicate, and/or connect to user input devices 911, peripheral devices 912, cryptographic processor devices 928, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 911 often are a type of peripheral device 912 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 912 may be connected and/or communicate to I/O and/or other facilities of the like such as network interfaces, storage interfaces, directly to the interface bus, system bus, the CPU, and/or the like. Peripheral devices may be external, internal and/or part of the PTT controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 928), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the PTT controller may be embodied as an embedded, dedicated, and/or monitor-less (i.e., headless) device, wherein access would be provided over a network interface connection.

Cryptographic units such as, but not limited to, microcontrollers, processors 926, interfaces 927, and/or devices 928 may be attached, and/or communicate with the PTT controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 929. However, memory is a fungible technology and resource, thus, any number of memory embodiments may be employed in lieu of or in concert with one another. It is to be understood that the PTT controller and/or a computer systemization may employ various forms of memory 929. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 929 will include ROM 906, RAM 905, and a storage device 914. A storage device 914 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 929 may contain a collection of program and/or database components and/or data such as, but not limited to: operating system component(s) 915 (operating system); information server component(s) 916 (information server); user interface component(s) 917 (user interface); Web browser component(s) 918 (Web browser); database(s) 919; mail server component(s) 921; mail client component(s) 922; cryptographic server component(s) 920 (cryptographic server); the PTT component(s) 935; and/or the like (i.e., collectively a component collection). These components may be stored and accessed from the storage devices and/or from storage devices accessible through an interface bus. Although non-conventional program components such as those in the component collection, typically, are stored in a local storage device 914, they may also be loaded and/or stored in memory such as: peripheral devices, RAM, remote storage facilities through a communications network, ROM, various forms of memory, and/or the like.

### Operating System

The operating system component 915 is an executable program component facilitating the operation of the PTT controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the PTT controller to communicate with other entities through a communications network 913. Various communication protocols may be used by the PTT controller as a subcarrier transport mechanism for interaction, such as, but not limited to: multicast, TCP/IP, UDP, unicast, and/or the like.

### Information Server

An information server component 916 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective−) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the PTT controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the PTT database 919, operating systems, other program components, user interfaces, Web browsers, and/or the like.

Access to the PTT database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the PTT. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the PTT as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 917 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 918 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the PTT enabled nodes. The combined application may be nugatory on systems employing standard Web browsers.

### Mail Server

A mail server component 921 is a stored program component that is executed by a CPU 903. The mail server may be a conventional Internet mail server such as, but not limited to sendmail, Microsoft Exchange, and/or the like. The mail server may allow for the execution of program components through facilities such as ASP, ActiveX, (ANSI) (Objective−) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the PTT.

Access to the PTT mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 922 is a stored program component that is executed by a CPU 903. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 920 is a stored program component that is executed by a CPU 903, cryptographic processor 926, cryptographic processor interface 927, cryptographic processor device 928, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the PTT may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the PTT component to engage in secure transactions if so desired. The cryptographic component facilitates the secure accessing of resources on the PTT and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The PTT Database

The PTT database component 919 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the PTT database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the PTT database is implemented as a data-structure, the use of the PTT database 919 may be integrated into another component such as the PTT component 935. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 919 includes several tables 919a-k. A Users table 919a may include fields such as, but not limited to: user_id, ssn, dob, first_name, last_name, age, state, address_firstline, address_secondline, zipcode, devices_list, contact_info, contact_type, alt_contact_info, alt_contact_type, and/or the like. The Users table may support and/or track multiple entity accounts on a PTT. A Clients table 919b may include fields such as, but not limited to: user_id, company_id, security_access_certificate, client_id, client_ip, client_type, client_model, operating_system, os_version, app_installed_flag, and/or the like. A Managers table 919c may include fields such as, but not limited to: manager_id, manager_type, process_groups_list, geographical_authority_list, ssn, dob, first_name, last_name, age, state, address_firstline, address_secondline, zipcode, devices_list, contact_info, contact_type, alt_contact_info, alt_contact_type, and/or the like. A Process Templates table 919d may include fields such as, but not limited to: process_id, process_group, process_level_list, process_definition_list, process_context, process_narrative, optimized_flag, global_flag, legal_limits, jurisdiction_limits, hardware_list, software_list, hr_list, and/or the like. A Baseline Processes table 919e may include fields such as, but not limited to: process_id, company_id, security_level, process_group, process_level_list, process_definition_list, process_context, process_narrative, optimized_flag, global_flag, legal_limits, jurisdiction_limits, hardware_list, software_list, hr_list, and/or the like. An Optimized Processes table 919f may include fields such as, but not limited to: process_id, company_id, security_level, process_group, process_level_list, process_definition_list, process_context, process_narrative, optimized_flag, global_flag, legal_limits, jurisdiction_limits, hardware_list, software_list, hr_list, and/or the like. A KPIs table 919g may include fields such as, but not limited to: process-Id, client_id, company_id, indicator_type, indicator_estimate, and/or the like. A Training Modules table 919h may include fields such as, but not limited to: process_id, process_type, cost_estimate, training_resource_list, and/or the like. An Impact Assessments table 919i may include fields such as, but not limited to: process_id, baseline_id, security_level, process_group, process_level_list, process_definition_list, process_context, process_narrative, optimized_flag, global_flag, legal_limits, jurisdiction_limits, hardware_list, software_list, hr_list, and/or the like. A Process Inputs table 919j may include fields such as, but not limited to: process_id, input_type, input_needlevel, input_format, and/or the like. A Process Outcomes table 919k may include fields such as, but not limited to: process_id, output_type, output_needlevel, output_format, and/or the like. A Modification Contingencies table(s) 919l may include fields such as, but not limited to, those described in FIG. 8 herein and related descriptions. These fields include modification_id, modification_type, modification_description, logic_differential, logic_addition, logic_deletion, text_differential, text_addition, text_deletion, id_differential, id_addition, id_deletion, template_range_start, template_range_end, process_step_addition, process_step_deletion, process_logic_addition, process_logic_deletion, application_rule.

In one embodiment, the PTT database may interact with other database systems. For example, employing a distributed database system, queries and data access by search PTT component may treat the combination of the PTT database, an integrated data security layer database as a single database entity.

In one embodiment, user programs may contain various user interface primitives, which may serve to update the PTT. Also, various accounts may require custom database tables depending upon the environments and the types of clients the PTT may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 919a-k. The PTT may be configured to keep track of various settings, inputs, and parameters via database controllers.

The PTT database may communicate to and/or with other components in a component collection, including itself, and/or facilities of the like. Most frequently, the PTT database communicates with the PTT component, other program components, and/or the like. The database may contain, retain, and provide information regarding other nodes and data.

### The PTTs

The PTT component 935 is a stored program component that is executed by a CPU. In one embodiment, the PTT component incorporates any and/or all combinations of the aspects of the PTT discussed in the previous figures. As such, the PTT affects accessing, obtaining and the provision of information, services, transactions, and/or the like across various communications networks.

The PTT component may transform unoptimized locally-deployable baseline processes via PTT components into custom globally optimized processes and transition materials, and/or the like and use of the PTT. In one embodiment, the PTT component 935 takes inputs (e.g., optimization request input 211, sub-process identification input 214, sub-process template matching trigger 217, process template data 219, approval input 226, template process performance metrics, KPIs, training modules 230, document processing request input 611, process identification input 614, process data 616, document processing initiation input 620, and/or the like), and transforms the inputs via various components (e.g., OPT 841, PMI 842, TIA 843, OPU 844, and/or the like), into outputs (e.g., request notification 213, sub-process resolution confirmation 216, custom optimized processes 228, custom optimized process metrics, KPIs, training schedules, etc. 232, document processing request notification, document processing order 618, document processing initiation notification 621, document processing confirmation 622, and/or the like).

The PTT component enabling access of information between nodes may be developed by employing standard development tools and languages such as, but not limited to: Apache components, Assembly, ActiveX, binary executables, (ANSI) (Objective−) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the PTT server employs a cryptographic server to encrypt and decrypt communications. The PTT component may communicate to and/or with other components in a component collection, including itself, and/or facilities of the like. Most frequently, the PTT component communicates with the PTT database, operating systems, other program components, and/or the like. The PTT may contain, communicate, generate, obtain, and/or provide program component, system, user, and/or data communications, requests, and/or responses.

### Distributed PTTs

The structure and/or operation of any of the PTT node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the PTT controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the PTT controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

<?PHP
header(′Content-Type: text/plain′);
// set ip address and port to listen to for incoming data
$address = ’192.168.0.100’;
$port = 255;
// create a server-side SSL socket, listen for/accept incoming
communication
$sock = socket_create(AF_INET, SOCK_STREAM, 0);
socket_bind($sock, $address, $port) or die(’Could not bind to
address’);
socket_listen($sock);
$client = socket_accept($sock);
// read input data from client device in 1024 byte blocks until end of
message
do {

$input = ””;
$input = socket_read($client, 1024);
$data .= $input;

} while($input != ””);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(”INSERT INTO UserTable (transmission)
VALUES ($data)”); // add data to UserTable table in a CLIENT database
mysql_close(″CLIENT_DB.SQL″); // close connection to database
?>

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/com.ibm

.IBMDI.doc/referenceguide295.htm

and other parser implementations:

http://publib.boulder.ibm.com/infocenter/tivihelp/v2r1/index.jsp?topic=/com.ibm

.IBMDI.doc/referenceguide259.htm

all of which are hereby expressly incorporated by reference.

In order to address various issues and advance the art, the entirety of this application for PROCESS TRANSFORMATION AND TRANSITIONING APPARATUSES, METHODS AND SYSTEMS (including the Cover Page, Title, Headings, Field, Background, Summary, Brief Description of the Drawings, Detailed Description, Claims, Abstract, Figures, Appendices and/or otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims. It is to be understood that, depending on the particular needs and/or characteristics of a PTT individual and/or enterprise user, database configuration and/or relational model, data type, data transmission and/or network framework, syntax structure, and/or the like, various embodiments of the PTT may be implemented that enable a great deal of flexibility and customization. For example, aspects of the PTT may be adapted for equipment optimization, manufacturing process optimization, and/or the like. While various embodiments and discussions of the PTT have been directed to global process optimization, however, it is to be understood that the embodiments described herein may be readily configured and/or customized for a wide variety of other applications and/or implementations.

APPENDIX A

| Job Family | Level 0 | Level 1 | Level 2 | Level 3 | Level 4 |
|---|---|---|---|---|---|
| N/A | Order to Cash | Order Management | OM1.0 Master Data | OM1.1 Product Master Data | OM1.1.1 Maintain Product MD |
| N/A | Order to Cash | Order Management | OM1.0 Master Data | OM1.1 Product Master Data | OM1.1.2 Maintain Price List |
| N/A | Order to Cash | Order Management | OM1.0 Master Data | OM1.2 Project Master Data | OM1.2.1 Maintain Project |
| N/A | Order to Cash | Order Management | OM1.0 Master Data | OM1.2 Project Master Data | OM1.2.2 Close Project |
| N/A | Order to Cash | Order Management | OM2.0 Order | OM2.1 Offers Management | OM2.1.1 Respond to Customer Inquiry |
| N/A | Order to Cash | Order Management | OM2.0 Order | OM2.2 Orders Creation | OM2.2.1 Process Manual Order |
| N/A | Order to Cash | Order Management | OM2.0 Order | OM2.2 Orders Creation | OM2.2.2 Process Electronic Order |
| N/A | Order to Cash | Order Management | OM2.0 Order | OM2.3 Manage Orders | OM2.3.1 Modify/Cancel Order |
| N/A | Order to Cash | Order Management | OM2.0 Order | OM2.4 Send Orders | OM2.4.1 Send Customer Order |
| N/A | Order to Cash | Order Management | OM2.0 Order | OM2.5 Inquire Management | OM2.5.1 Process Order Return |
| N/A | Order to Cash | Order Management | OM2.0 Order | OM2.5 Inquire Management | OM2.5.2 Process Order Exchange |
| N/A | Order to Cash | Order Management | OM2.0 Order | OM2.5 Inquire Management | OM2.5.3 Process Price Claim |
| N/A | Order to Cash | Order Management | OM3.0 Project Accounting | OM3.1 Project Bookings | OM3.1.1 Process Reported Time |
| N/A | Order to Cash | Order Management | OM3.0 Project Accounting | OM3.1 Project Bookings | OM3.1.2 Process Expenses & Other Costs |
| N/A | Order to Cash | Order Management | OM3.0 Project Accounting | OM3.2 Project Monitoring | OM3.2.1 Reconcile WIP BIA |
| N/A | Order to Cash | Order Management | OM3.0 Project Accounting | OM3.2 Project Monitoring | OM3.2.2 Reconcile Subcontractor |
| N/A | Order to Cash | Order Management | OM4.0 Query | OM4.1 Customer Queries | OM4.1.1 Resolve Customer Query |
| N/A | Order to Cash | Order Management | OM4.0 Query | OM4.2 Audit Requests | OM4.2.1 Respond to Audit Request |
| N/A | Order to Cash | Order Management | OM5.0 Reporting | OM5.1 Management Reporting | OM5.1.1 Perform Business Analysis |
| N/A | Order to Cash | Order Management | OM5.0 Reporting | OM5.1 Management Reporting | OM5.1.2 Prepare Management Report |
| N/A | Order to Cash | Order Management | OM5.0 Reporting | OM5.2 Ad-hoc Reporting | OM5.2.1 Produce Ad-hoc Report |
| N/A | Order to Cash | Order Management | OM6.0 Document Management | OM6.1 Archive Documents | OM6.1.1 Archive Document |
| N/A | Order to Cash | Order Management | OM6.0 Document Management | OM6.2 Retrieve Documents | OM6.2.1 Retrieve Document |
| N/A | Order to Cash | Order Management | OM6.0 Document Management | OM6.3 Destroy Documents | OM6.3.1 Destroy Archived Document |
| Credit Management | Order to Cash | Bill to Cash | B2C1.0 Credit | B2C1.1 Manage Credit Review | B2C1.1.1 Assess Credit Worthiness |
| Credit Management | Order to Cash | Bill to Cash | B2C1.0 Credit | B2C1.1 Manage Credit Review | B2C1.1.2 Automatic Credit Limit Review |
| Credit Management | Order to Cash | Bill to Cash | B2C1.0 Credit | B2C1.1 Manage Credit Review | B2C1.1.3 Review/Monitor Existing Credit Profile |
| Credit Management | Order to Cash | Bill to Cash | B2C1.0 Credit | B2C1.1 Manage Credit Review | B2C1.1.4 Orders on Credit Hold |
| Record & Report | Order to Cash | Bill to Cash | B2C2.0 Master Data | B2C2.1 Create and Maintain Cust. Data | B2C2.1.1 Perform Customer Maintenance |
| Record & Report | Order to Cash | Bill to Cash | B2C2.0 Master Data | B2C2.1 Create and Maintain Cust. Data | B2C2.1.2 Set up Direct Debit |
| Record & Report | Order to Cash | Bill to Cash | B2C2.0 Master Data | B2C2.1 Create and Maintain Cust. Data | B2C2.1.3 Set up SEPA Direct Debit |
| Cash Applications | Order to Cash | Bill to Cash | B2C3.0 Billing | B2C3.1 Create Billing Documents | B2C3.1.1 Process Electronic Billing Doc. |
| Cash Applications | Order to Cash | Bill to Cash | B2C3.0 Billing | B2C3.1 Create Billing Documents | B2C3.1.2 Process Manual Billing Document |
| Cash Applications | Order to Cash | Bill to Cash | B2C3.0 Billing | B2C3.2 Send Billing Doc. | B2C3.2.1 Billing Document Distribution |
| Collection | Order to Cash | Bill to Cash | B2C4.0 Collection | B2C4.1 Collect Outstanding Debt | B2C4.1.1 Collect From Large Customer (Tier 1) |
| Collection | Order to Cash | Bill to Cash | B2C4.0 Collection | B2C4.1 Collect Outstanding Debt | B2C4.1.2 Collect From Medium Customer (Tier 2) |
| Collection | Order to Cash | Bill to Cash | B2C4.0 Collection | B2C4.1 Collect Outstanding Debt | B2C4.1.3 Collect From Small Customer (Tier 3) |
| Collection | Order to Cash | Bill to Cash | B2C4.0 Collection | B2C4.1 Collect Outstanding Debt | B2C4.1.4 Retained Collection |
| Collection | Order to Cash | Bill to Cash | B2C4.0 Collection | B2C4.1 Collect Outstanding Debt | B2C4.1.5 Escalate unpaid amounts |
| Collection | Order to Cash | Bill to Cash | B2C4.0 Collection | B2C4.1 Collect Outstanding Debt | B2C4.1.6 Perform Dunning |
| Collection | Order to Cash | Bill to Cash | B2C4.0 Collection | B2C4.1 Collect Outstanding Debt | B2C4.1.7 Create and send statement |
| Collection | Order to Cash | Bill to Cash | B2C4.0 Collection | B2C4.2 Doubtful Receivables | B2C4.2.1 3rd party referral |
| Collection | Order to Cash | Bill to Cash | B2C4.0 Collection | B2C4.2 Doubtful Receivables | B2C4.2.2 Process Bankrupt/Insolvent Accounts |
| Collection | Order to Cash | Bill to Cash | B2C4.0 Collection | B2C4.2 Doubtful Receivables | B2C4.2.3 Agree Settlement |
| Collection | Order to Cash | Bill to Cash | B2C4.0 Collection | B2C4.2 Doubtful Receivables | B2C4.2.4 Take legal action |
| Collection | Order to Cash | Bill to Cash | B2C4.0 Collection | B2C4.2 Doubtful Receivables | B2C4.2.5 Process write off |
| Collection | Order to Cash | Bill to Cash | B2C4.0 Collection | B2C4.2 Doubtful Receivables | B2C4.2.6 Process Fraudulent Account |
| Cash Applications | Order to Cash | Bill to Cash | B2C5.0 Cash | B2C5.1 Cash Application | B2C5.1.1 Receive Payments |
| Cash Applications | Order to Cash | Bill to Cash | B2C5.0 Cash | B2C5.1 Cash Application | B2C5.1.2 Process Auto Match Payment |
| Cash Applications | Order to Cash | Bill to Cash | B2C5.0 Cash | B2C5.1 Cash Application | B2C5.1.3 Resolve Non-Matched Payments |
| Cash Applications | Order to Cash | Bill to Cash | B2C5.0 Cash | B2C5.2 Miscellaneous | B2C5.2.1 Customer Clearing |
| Cash Applications | Order to Cash | Bill to Cash | B2C5.0 Cash | B2C5.2 Miscellaneous | B2C5.2.2 Direct Debit |
| Cash Applications | Order to Cash | Bill to Cash | B2C5.0 Cash | B2C5.2 Miscellaneous | B2C5.2.3 SEPA Direct Debit |
| Cash Applications | Order to Cash | Bill to Cash | B2C5.0 Cash | B2C5.2 Miscellaneous | B2C5.2.4 SEPA R-transaction Handling |
| Cash Applications | Order to Cash | Bill to Cash | B2C5.0 Cash | B2C5.2 Miscellaneous | B2C5.2.5 Credit Card Payment |
| Cash Applications | Order to Cash | Bill to Cash | B2C5.0 Cash | B2C5.2 Miscellaneous | B2C5.2.6 Traite (Bill of Exchange-France) |
| Cash Applications | Order to Cash | Bill to Cash | B2C5.0 Cash | B2C5.2 Miscellaneous | B2C5.2.7 Payment Reversal |
| Cash Applications | Order to Cash | Bill to Cash | B2C5.0 Cash | B2C5.2 Miscellaneous | B2C5.2.8 Refund to Customer |
| Collection | Order to Cash | Bill to Cash | B2C6.0 Disputes, Deductions and Qrys. | B2C6.1 Dispute Management | B2C6.1.1 Resolve Dispute |
| Collection | Order to Cash | Bill to Cash | B2C6.0 Disputes, Deductions and Qrys. | B2C6.2 Deduction Management | B2C6.2.1 Resolve Deduction |
| Helpdesk | Order to Cash | Bill to Cash | B2C6.0 Disputes, Deductions and Qrys. | B2C6.3 Customer Queries | B2C6.3.1 Resolve Customer Query |
| Helpdesk | Order to Cash | Bill to Cash | B2C6.0 Disputes, Deductions and Qrys. | B2C6.3 Customer Queries | B2C6.3.2 Audit Requests |
| Credit Management | Order to Cash | Bill to Cash | B2C7.0 Reporting | B2C7.1 Management Reporting | B2C7.1.1 Prepare Management Report and |
| | | | | | Business Analysis |
| Credit Management | Order to Cash | Bill to Cash | B2C7.0 Reporting | B2C7.2 - Ad-Hoc Reporting | B2C7.2.1 Produce Ad-Hoc Report |
| Cash Applications | Order to Cash | Bill to Cash | B2C8.0 Document Management | B2C8.1 Archive | B2C8.1.1 Archive Documents |
| Cash Applications | Order to Cash | Bill to Cash | B2C8.0 Document Management | B2C8.2 Retrieve Documents | B2C8.2.1 Retrieve Archived Document |
| Cash Applications | Order to Cash | Bill to Cash | B2C8.0 Document Management | B2C8.3 Destroy Documents | B2C8.3.1 Destroy Archived Document |
| Governance | Order to Cash | Content Lifecycle Mgmt. | CLM1.0 Governance | CLM1.1. Managerial Process | CLM1.1.1 Change Control Management |
| Governance | Order to Cash | Content Lifecycle Mgmt. | CLM1.0 Governance | CLM1.1. Managerial Process | CLM1.1.2 Capacity Management |
| Governance | Order to Cash | Content Lifecycle Mgmt. | CLM1.0 Governance | CLM1.1. Managerial Process | CLM1.1.3 Effort Dispute Resolution |
| Governance | Order to Cash | Content Lifecycle Mgmt. | CLM1.0 Governance | CLM1.1. Managerial Process | CLM1.1.4 Resource Management |
| Governance | Order to Cash | Content Lifecycle Mgmt. | CLM1.0 Governance | CLM1.1. Managerial Process | CLM1.1.5 Delivery Management |
| Governance | Order to Cash | Content Lifecycle Mgmt. | CLM1.0 Governance | CLM1.1. Managerial Process | CLM1.1.6 Reporting |
| Governance | Order to Cash | Content Lifecycle Mgmt. | CLM1.0 Governance | CLM1.1. Managerial Process | CLM1.1.7 Risk Management |
| Governance | Order to Cash | Content Lifecycle Mgmt. | CLM1.0 Governance | CLM1.2. Quality Assurance | CLM1.2.1 Process Re-Engineering |
| Governance | Order to Cash | Content Lifecycle Mgmt. | CLM1.0 Governance | CLM1.2. Quality Assurance | CLM1.2.2 Root Cause Analysis |
| Governance | Order to Cash | Content Lifecycle Mgmt. | CLM1.0 Governance | CLM1.2. Quality Assurance | CLM1.2.3 Process Development Update |
| Governance | Order to Cash | Content Lifecycle Mgmt. | CLM1.0 Governance | CLM1.3. Knowledge Process | CLM1.3.1 Knowledge Management |
| Governance | Order to Cash | Content Lifecycle Mgmt. | CLM1.0 Governance | CLM1.3. Knowledge Process | CLM1.3.2 Training |
| Governance | Order to Cash | Content Lifecycle Mgmt. | CLM1.0 Governance | CLM1.3. Knowledge Process | CLM1.3.3 Knowledge Audit |
| Governance | Order to Cash | Content Lifecycle Mgmt. | CLM1.0 Governance | CLM1.4. Tools & Technology Mgmt. | CLM1.4.1 Identify and Verify Issue |
| Governance | Order to Cash | Content Lifecycle Mgmt. | CLM1.0 Governance | CLM1.4. Tools & Technology Mgmt. | CLM1.4.2 Open Ticket |
| Governance | Order to Cash | Content Lifecycle Mgmt. | CLM1.0 Governance | CLM1.4. Tools & Technology Mgmt. | CLM1.4.3 Contact External Provider |
| Governance | Order to Cash | Content Lifecycle Mgmt. | CLM1.0 Governance | CLM1.4. Tools & Technology Mgmt. | CLM1.4.4 Track and Update Issue |
| Governance | Order to Cash | Content Lifecycle Mgmt. | CLM1.0 Governance | CLM1.4. Tools & Technology Mgmt. | CLM1.4.5 Communicate Status |
| Governance | Order to Cash | Content Lifecycle Mgmt. | CLM1.0 Governance | CLM1.4. Tools & Technology Mgmt. | CLM1.4.6 Verify Resolution |
| Content Management | Order to Cash | Content Lifecycle Mgmt. | CLM2.0 Content Management | CLM2.1. Capture/Content Information Arch. | CLM2.1.1 Standards & Guidelines Setup |
| Content Management | Order to Cash | Content Lifecycle Mgmt. | CLM2.0 Content Management | CLM2.1. Capture/Content Information Arch. | CLM2.1.2 Tools & Technology Setup |
| Content Management | Order to Cash | Content Lifecycle Mgmt. | CLM2.0 Content Management | CLM2.1. Capture/Content Information Arch. | CLM2.1.3 Workflow Setup |
| Content Management | Order to Cash | Content Lifecycle Mgmt. | CLM2.0 Content Management | CLM2.1. Capture/Content Information Arch. | CLM2.1.4 Access & Roles Setup |
| Content Management | Order to Cash | Content Lifecycle Mgmt. | CLM2.0 Content Management | CLM2.1. Capture/Content Information Arch. | CLM2.1.5 Metadata Definition |
| Content Management | Order to Cash | Content Lifecycle Mgmt. | CLM2.0 Content Management | CLM2.1. Capture/Content Information Arch. | CLM2.1.6 Versioning Policy Setup |
| Content Management | Order to Cash | Content Lifecycle Mgmt. | CLM2.0 Content Management | CLM2.1. Capture/Content Information Arch. | CLM2.1.7 Configuration Management Policy Setup |
| Content Management | Order to Cash | Content Lifecycle Mgmt. | CLM2.0 Content Management | CLM2.1. Capture/Content Information Arch. | CLM2.1.8 Publish Deploy Policy Setup |
| Content Management | Order to Cash | Content Lifecycle Mgmt. | CLM2.0 Content Management | CLM2.1. Capture/Content Information Arch. | CLM2.1.9 Archival/Retrival/Destruction Policy Setup |
| Content Management | Order to Cash | Content Lifecycle Mgmt. | CLM2.0 Content Management | CLM2.2. Create/Update | CLM2.2.1 Work Packaging |
| Content Management | Order to Cash | Content Lifecycle Mgmt. | CLM2.0 Content Management | CLM2.2. Create/Update | CLM2.2.2 Source Data Analysis |
| Content Management | Order to Cash | Content Lifecycle Mgmt. | CLM2.0 Content Management | CLM2.2. Create/Update | CLM2.2.3 Create/Update |
| Content Management | Order to Cash | Content Lifecycle Mgmt. | CLM2.0 Content Management | CLM2.2. Create/Update | CLM2.2.4 Content Applicability |
| Content Management | Order to Cash | Content Lifecycle Mgmt. | CLM2.0 Content Management | CLM2.2. Create/Update | CLM2.2.5 Content Versioning |
| Content Management | Order to Cash | Content Lifecycle Mgmt. | CLM2.0 Content Management | CLM2.3. Store/Index/Share/Collaborate | CLM2.3.1 Store/Index |
| Content Management | Order to Cash | Content Lifecycle Mgmt. | CLM2.0 Content Management | CLM2.3. Store/Index/Share/Collaborate | CLM2.3.2 Share/Collaborate |
| Content Management | Order to Cash | Content Lifecycle Mgmt. | CLM2.0 Content Management | CLM2.4. Translate | CLM2.4.1 Content Translation |
| Content Management | Order to Cash | Content Lifecycle Mgmt. | CLM2.0 Content Management | CLM2.5. Quality Audit | CLM2.5.1 Content Review process |
| Content Management | Order to Cash | Content Lifecycle Mgmt. | CLM2.0 Content Management | CLM2.6. Publish/Deploy | CLM2.6.1 Content Publishing/deployment |
| Content Management | Order to Cash | Content Lifecycle Mgmt. | CLM2.0 Content Management | CLM2.6. Publish/Deploy | CLM2.6.2 Content Archival/Destruction |
| Content Management | Order to Cash | Content Lifecycle Mgmt. | CLM2.0 Content Management | CLM2.6. Publish/Deploy | CLM2.6.3 Content Retrieval |
| Command Center | Production & Service | Customer Interaction | CIM1.0 Command Center | CIM1.1. Work Force Management | CIM1.1.1 Create Forecast Model |
| | | Mgmt. | | | |
| Command Center | Production & Service | Customer Interaction | CIM1.0 Command Center | CIM1.1. Work Force Management | CIM1.1.2 Review Forecast Generation |
| | | Mgmt. | | | |
| Command Center | Production & Service | Customer Interaction | CIM1.0 Command Center | CIM1.1. Work Force Management | CIM1.1.3 Create Schedule in WFM |
| | | Mgmt. | | | |
| Command Center | Production & Service | Customer Interaction | CIM1.0 Command Center | CIM1.1. Work Force Management | CIM1.1.4 Review Schedules |
| | | Mgmt. | | | |
| Command Center | Production & Service | Customer Interaction | CIM1.0 Command Center | CIM1.1. Work Force Management | CIM1.1.5 Create Interval Level Reports |
| | | Mgmt. | | | |
| Command Center | Production & Service | Customer Interaction | CIM1.0 Command Center | CIM1.1. Work Force Management | CIM1.1.6 Manage Shift Schedules |
| | | Mgmt. | | | |
| Command Center | Production & Service | Customer Interaction | CIM1.0 Command Center | CIM1.1. Work Force Management | CIM1.1.7 Real Time Monitoring |
| | | Mgmt. | | | |
| Command Center | Production & Service | Customer Interaction | CIM1.0 Command Center | CIM1.1. Work Force Management | CIM1.1.8 Activity Management |
| | | Mgmt. | | | |
| Command Center | Production & Service | Customer Interaction | CIM1.0 Command Center | CIM1.1. Work Force Management | CIM1.1.9 Reporting |
| | | Mgmt. | | | |
| Command Center | Production & Service | Customer Interaction | CIM1.0 Command Center | CIM1.2. Quality Process | CIM1.2.1 Knowledge Capture Process Documentation |
| | | Mgmt. | | | |
| Command Center | Production & Service | Customer Interaction | CIM1.0 Command Center | CIM1.2. Quality Process | CIM1.2.2 QA Develop Quality Project |
| | | Mgmt. | | | |
| Command Center | Production & Service | Customer Interaction | CIM1.0 Command Center | CIM1.2. Quality Process | CIM1.2.3 QA Day Level |
| | | Mgmt. | | | |
| Command Center | Production & Service | Customer Interaction | CIM1.0 Command Center | CIM1.2. Quality Process | CIM1.2.4 QA Customer Protective Environment |
| | | Mgmt. | | | |
| Command Center | Production & Service | Customer Interaction | CIM1.0 Command Center | CIM1.2. Quality Process | CIM1.2.5 QA CSAT Survey |
| | | Mgmt. | | | |
| Command Center | Production & Service | Customer Interaction | CIM1.0 Command Center | CIM1.2. Quality Process | CIM1.2.6 QA Evaluation Monitoring |
| | | Mgmt. | | | |
| Command Center | Production & Service | Customer Interaction | CIM1.0 Command Center | CIM1.2. Quality Process | CIM1.2.7 QA Process Update |
| | | Mgmt. | | | |
| Command Center | Production & Service | Customer Interaction | CIM1.0 Command Center | CIM1.2. Quality Process | CIM1.2.8 QA Calibration |
| | | Mgmt. | | | |
| Command Center | Production & Service | Customer Interaction | CIM1.0 Command Center | CIM1.2. Quality Process | CIM1.2.9 QA Alerts |
| | | Mgmt. | | | |
| Command Center | Production & Service | Customer Interaction | CIM1.0 Command Center | CIM1.2. Quality Process | CIM1.2.10 QA QFS Process |
| | | Mgmt. | | | |
| Command Center | Production & Service | Customer Interaction | CIM1.0 Command Center | CIM1.2. Quality Process | CIM1.2.11 QA Report Process |
| | | Mgmt. | | | |
| Command Center | Production & Service | Customer Interaction | CIM1.0 Command Center | CIM1.2. Quality Process | CIM1.2.12 QA SOP Action Planning |
| | | Mgmt. | | | |
| Command Center | Production & Service | Customer Interaction | CIM1.0 Command Center | CIM1.2. Quality Process | CIM1.2.13 Nexidia Reports Analysis |
| | | Mgmt. | | | |
| Command Center | Production & Service | Customer Interaction | CIM1.0 Command Center | CIM1.2. Quality Process | CIM1.2.14 QA Dispute |
| | | Mgmt. | | | |
| Command Center | Production & Service | Customer Interaction | CIM1.0 Command Center | CIM1.2. Quality Process | CIM1.2.15 QA Review and Analyze QA Reports |
| | | Mgmt. | | | |
| Command Center | Production & Service | Customer Interaction | CIM1.0 Command Center | CIM1.2. Quality Process | CIM1.2.16 QA Mystery Shopper Call Level |
| | | Mgmt. | | | |
| Command Center | Production & Service | Customer Interaction | CIM1.0 Command Center | CIM1.2. Quality Process | CIM1.2.17 QA DAP Process |
| | | Mgmt. | | | |
| Command Center | Production & Service | Customer Interaction | CIM1.0 Command Center | CIM1.2. Quality Process | CIM1.2.18 QA Knowledge Quiz |
| | | Mgmt. | | | |
| Command Center | Production & Service | Customer Interaction | CIM1.0 Command Center | CIM1.2. Quality Process | CIM1.2.19 QA Communication Skills |
| | | Mgmt. | | | |
| Command Center | Production & Service | Customer Interaction | CIM1.0 Command Center | CIM1.2. Quality Process | CIM1.2.20 QA Remote Silent Monitoring |
| | | Mgmt. | | | |
| Command Center | Production & Service | Customer Interaction | CIM1.0 Command Center | CIM1.2. Quality Process | CIM1.2.21 QA Disciplinary Process |
| | | Mgmt. | | | |
| Command Center | Production & Service | Customer Interaction | CIM1.0 Command Center | CIM1.2. Quality Process | CIM1.2.22 QA Call Process |
| | | Mgmt. | | | |
| Command Center | Production & Service | Customer Interaction | CIM1.0 Command Center | CIM1.2. Quality Process | CIM1.2.23 QA System Issues |
| | | Mgmt. | | | |
| Command Center | Production & Service | Customer Interaction | CIM1.0 Command Center | CIM1.2. Quality Process | CIM1.2.24 QA Data Mining |
| | | Mgmt. | | | |
| Command Center | Production & Service | Customer Interaction | CIM1.0 Command Center | CIM1.2. Quality Process | CIM1.2.25 QA Tip Process |
| | | Mgmt. | | | |
| Command Center | Production & Service | Customer Interaction | CIM1.0 Command Center | CIM1.3. Social Media | CIM1.3.1 Data Gathering |
| | | Mgmt. | | | |
| Command Center | Production & Service | Customer Interaction | CIM1.0 Command Center | CIM1.3. Social Media | CIM1.3.2 Tools Set Up Level |
| | | Mgmt. | | | |
| Command Center | Production & Service | Customer Interaction | CIM1.0 Command Center | CIM1.3. Social Media | CIM1.3.3 Data Analysis |
| | | Mgmt. | | | |
| Command Center | Production & Service | Customer Interaction | CIM1.0 Command Center | CIM1.3. Social Media | CIM1.3.4 Action Positive |
| | | Mgmt. | | | |
| Command Center | Production & Service | Customer Interaction | CIM1.0 Command Center | CIM1.3. Social Media | CIM1.3.5 Action Negative |
| | | Mgmt. | | | |
| Command Center | Production & Service | Customer Interaction | CIM1.0 Command Center | CIM1.3. Social Media | CIM1.3.6 Business Process Improvement |
| | | Mgmt. | | | |
| Command Center | Production & Service | Customer Interaction | CIM1.0 Command Center | CIM1.3. Social Media | CIM1.3.7 Record |
| | | Mgmt. | | | |
| Command Center | Production & Service | Customer Interaction | CIM1.0 Command Center | CIM1.4. Data Insight | CIM1.4.1 Collect Data Sources |
| | | Mgmt. | | | |
| Command Center | Production & Service | Customer Interaction | CIM1.0 Command Center | CIM1.4. Data Insight | CIM1.4.2 Populate Data Repository |
| | | Mgmt. | | | |
| Command Center | Production & Service | Customer Interaction | CIM1.0 Command Center | CIM1.4. Data Insight | CIM1.4.3 Determine Data Insight Needs |
| | | Mgmt. | | | |
| Command Center | Production & Service | Customer Interaction | CIM1.0 Command Center | CIM1.4. Data Insight | CIM1.4.4 Generate Scheduled Reports |
| | | Mgmt. | | | |
| Command Center | Production & Service | Customer Interaction | CIM1.0 Command Center | CIM1.4. Data Insight | CIM1.4.5 Alerts |
| | | Mgmt. | | | |
| Command Center | Production & Service | Customer Interaction | CIM1.0 Command Center | CIM1.4. Data Insight | CIM1.4.6 Generate Insight Analysis |
| | | Mgmt. | | | |
| Command Center | Production & Service | Customer Interaction | CIM1.0 Command Center | CIM1.4. Data Insight | CIM1.4.7 Distribute |
| | | Mgmt. | | | |
| Command Center | Production & Service | Customer Interaction | CIM1.0 Command Center | CIM1.5. Knowledge Process | CIM1.5.1 Process and Change Control |
| | | Mgmt. | | | |
| Command Center | Production & Service | Customer Interaction | CIM1.0 Command Center | CIM1.5. Knowledge Process | CIM1.5.2 Update Change Details |
| | | Mgmt. | | | |
| Command Center | Production & Service | Customer Interaction | CIM1.0 Command Center | CIM1.5. Knowledge Process | CIM1.5.3 Update the KB |
| | | Mgmt. | | | |
| Command Center | Production & Service | Customer Interaction | CIM1.0 Command Center | CIM1.5. Knowledge Process | CIM1.5.4 Change Complete Notification |
| | | Mgmt. | | | |
| Command Center | Production & Service | Customer Interaction | CIM1.0 Command Center | CIM1.6. Tools & Technology Management | CIM1.6.1 Identify and Verify Issue |
| | | Mgmt. | | | |
| Command Center | Production & Service | Customer Interaction | CIM1.0 Command Center | CIM1.6. Tools & Technology Management | CIM1.6.2 Open Ticket |
| | | Mgmt. | | | |
| Command Center | Production & Service | Customer Interaction | CIM1.0 Command Center | CIM1.6. Tools & Technology Management | CIM1.6.3 Contact External Provider |
| | | Mgmt. | | | |
| Command Center | Production & Service | Customer Interaction | CIM1.0 Command Center | CIM1.6. Tools & Technology Management | CIM1.6.4 Track and Update Issue |
| | | Mgmt. | | | |
| Command Center | Production & Service | Customer Interaction | CIM1.0 Command Center | CIM1.6. Tools & Technology Management | CIM1.6.5 Communicate Status |
| | | Mgmt. | | | |
| Command Center | Production & Service | Customer Interaction | CIM1.0 Command Center | CIM1.6. Tools & Technology Management | CIM1.6.6 Verify Resolution |
| | | Mgmt. | | | |
| Helpdesk | Production & Service | Customer Interaction | CIM2.0 Operations Management | CIM2.1. Training | CIM2.1.1 Training Delivery |
| | | Mgmt. | | | |
| Helpdesk | Production & Service | Customer Interaction | CIM2.0 Operations Management | CIM2.1. Training | CIM2.1.2 Remediation |
| | | Mgmt. | | | |
| Helpdesk | Production & Service | Customer Interaction | CIM2.0 Operations Management | CIM2.2. Customer Interaction Contact Flow | CIM2.2.1 Contact Greeting |
| | | Mgmt. | | | |
| Helpdesk | Production & Service | Customer Interaction | CIM2.0 Operations Management | CIM2.2. Customer Interaction Contact Flow | CIM2.2.2 Acknowledgment of Request |
| | | Mgmt. | | | |
| Helpdesk | Production & Service | Customer Interaction | CIM2.0 Operations Management | CIM2.2. Customer Interaction Contact Flow | CIM2.2.3 Contact Verification |
| | | Mgmt. | | | |
| Helpdesk | Production & Service | Customer Interaction | CIM2.0 Operations Management | CIM2.2. Customer Interaction Contact Flow | CIM2.2.4 Contact Compliance |
| | | Mgmt. | | | |
| R2A - Master Data | Record to Analyse | Record and Account | RA1.0 Master Data | RA1.1 Maintain Chart of Accounts | RA1.1.1 Chart of Accounts Maintenance - Creation |
| R2A - Master Data | Record to Analyse | Record and Account | RA1.0 Master Data | RA1.1 Maintain Chart of Accounts | RA1.1.2 Chart of Accounts Maintenance - Modify |
| R2A - Master Data | Record to Analyse | Record and Account | RA1.0 Master Data | RA1.1 Maintain Chart of Accounts | RA1.1.3 Chart of Accounts Quality/Usage Check |
| R2A - Master Data | Record to Analyse | Record and Account | RA1.0 Master Data | RA1.2 Maintain Capital Project MD | RA1.2.1 Process Capital Project MDM request |
| R2A - Master Data | Record to Analyse | Record and Account | RA1.0 Master Data | RA1.3 Maintain Reporting MD | RA1.3.1 Process Reporting MD M Request |
| R2A - Master Data | Record to Analyse | Record and Account | RA1.0 Master Data | RA1.4 Maintain Analysis MD | RA1.4.1 Process Analysis MDM Request |
| R2A - Master Data | Record to Analyse | Record and Account | RA1.0 Master Data | RA1.5 Maintain Fixed Assets MD | RA1.5.1 Process Fixed Assets MDM Request |
| R2A - Master Data | Record to Analyse | Record and Account | RA1.0 Master Data | RA1.6 Open New Accounting Period | RA1.6.1 Open New Accounting Period |
| R2A - Master Data | Record to Analyse | Record and Account | RA1.0 Master Data | RA1.7 Open New Accounting Period | RA1.7.1 Update Foreign Exchange rates Tables |
| R2A - Master Data | Record to Analyse | Record and Account | RA1.0 Master Data | RA1.8 Policies and Procedures | RA1.8.1 Update Group and Statutory |
| | | | | | Accounting Policies |
| R2A - Master Data | Record to Analyse | Record and Account | RA1.0 Master Data | RA1.8 Policies and Procedures | RA1.8.2 Implement Group and Statutory |
| | | | | | Accounting Policies Updates |
| R2A - Master Data | Record to Analyse | Record and Account | RA1.0 Master Data | RA1.8 Policies and Procedures | RA1.8.3 Define Group and Statutory Reporting |
| | | | | | Instructions |
| R2A - Master Data | Record to Analyse | Record and Account | RA1.0 Master Data | RA1.9 Profit Centre Masters | RA1.9.1 Profit Centre creation |
| R2A - Master Data | Record to Analyse | Record and Account | RA1.0 Master Data | RA1.9 Profit Centre Masters | RA1.9.2 Profit Centre Modification |
| R2A - Master Data | Record to Analyse | Record and Account | RA1.0 Master Data | RA1.10 Cost Centre Masters | RA1.10.1 Cost Centre Creation |
| R2A - Master Data | Record to Analyse | Record and Account | RA1.0 Master Data | RA1.10 Cost Centre Masters | RA1.10.2 Cost Centre Modification |
| R2A - Master Data | Record to Analyse | Record and Account | RA1.0 Master Data | RA1.10 Cost Centre Masters | RA1.10.3 Cost Centre Extension |
| R2A - Master Data | Record to Analyse | Record and Account | RA1.0 Master Data | RA1.11 Bank Masters | RA1.11.1 Bank Master Creation |
| R2A - Master Data | Record to Analyse | Record and Account | RA1.0 Master Data | RA1.11 Bank Masters | RA1.11.2 Bank Master Modification |
| R2A - Master Data | Record to Analyse | Record and Account | RA1.0 Master Data | RA1.11 Bank Masters | RA1.11.3 Bank Key Master Creation |
| R2A - Master Data | Record to Analyse | Record and Account | RA1.0 Master Data | RA1.11 Bank Masters | RA1.11.4 Bank Key Master Modification |
| R2A - Record | Record to Analyse | Record and Account | RA2.0 Journal | RA2.1 Journal Entries | RA2.1.1 Prepare Journal |
| R2A - Record | Record to Analyse | Record and Account | RA2.0 Journal | RA2.1 Journal Entries | RA2.1.2 Process Journal |
| R2A - Record | Record to Analyse | Record and Account | RA3.0 Fixed Asset | RA3.1 Fixed Asset Addition | RA3.1.1 Record Fixed Asset Purchase |
| R2A - Record | Record to Analyse | Record and Account | RA3.0 Fixed Asset | RA3.1 Fixed Asset Addition | RA3.1.2 WIP Internal Order Close |
| R2A - Record | Record to Analyse | Record and Account | RA3.0 Fixed Asset | RA3.1 Fixed Asset Addition | RA3.1.3 Periodic WIP Costs Settlements |
| R2A - Record | Record to Analyse | Record and Account | RA3.0 Fixed Asset | RA3.2 Fixed Asset Disposal and Impairmnt | RA3.2.1 Process Fixed Asset Disposal |
| R2A - Record | Record to Analyse | Record and Account | RA3.0 Fixed Asset | RA3.2 Fixed Asset Disposal and Impairmnt | RA3.2.2 Process Fixed Asset Impairment |
| R2A - Record | Record to Analyse | Record and Account | RA3.0 Fixed Asset | RA3.3Fixed Asset Transfer | RA3.3.1 Process Fixed Asset Transfer |
| R2A - Record | Record to Analyse | Record and Account | RA3.0 Fixed Asset | RA3.4 Close Fixed Assets | RA3.4.1 Process Fixed Asset Depreciation |
| R2A - Record | Record to Analyse | Record and Account | RA3.0 Fixed Asset | RA3.4 Close Fixed Assets | RA3.4.2 Process Fixed Asset Period End |
| R2A - Record | Record to Analyse | Record and Account | RA3.0 Fixed Asset | RA3.5 Fixed Assets Inventory Count | RA3.5.1 Process Fixed Assets Inventory |
| | | | | | Count Adjustments |
| R2A - Record | Record to Analyse | Record and Account | RA4.0 Capital Projects Accounting | RA4.1 Perform Capital Project Accounting | RA4.1.1 Record Capital Project Transactions |
| R2A - Record | Record to Analyse | Record and Account | RA4.0 Capital Projects Accounting | RA4.1 Perform Capital Project Accounting | RA4.1.2 Monitor Capital Project |
| R2A - Record | Record to Analyse | Record and Account | RA4.0 Capital Projects Accounting | RA4.1 Perform Capital Project Accounting | RA4.1.3 Analyse and Revise Capital Project |
| R2A - Record | Record to Analyse | Record and Account | RA4.0 Capital Projects Accounting | RA4.2 Close Capital Project | RA4.2.1 Capitalize Project |
| R2A - Record | Record to Analyse | Record and Account | RA5.0 Cost Accounting | RA5.1 Cost Accounting Method | RA5.1.1 Define Cost Accounting method |
| R2A - Record | Record to Analyse | Record and Account | RA5.0 Cost Accounting | RA5.2 Cost Accounting Preparation | RA5.2.1 Prepare Cost Allocation Set Up |
| R2A - Record | Record to Analyse | Record and Account | RA5.0 Cost Accounting | RA5.2 Cost Accounting Preparation | RA5.2.2 Prepare Cost Allocation Update |
| R2A - Record | Record to Analyse | Record and Account | RA6.0 Inventory Accounting | RA6.1 Inventory Valuation | RA6.1.1 Define Inventory Costing Method |
| R2A - Record | Record to Analyse | Record and Account | RA6.0 Inventory Accounting | RA6.1 Inventory Valuation | RA6.1.2 Prepare Inventory Cost Sheets |
| R2A - Record | Record to Analyse | Record and Account | RA6.0 Inventory Accounting | RA6.1 Inventory Valuation | RA6.1.3 Prepare Inventory Valuation |
| R2A - Record | Record to Analyse | Record and Account | RA6.0 Inventory Accounting | RA6.1 Inventory Valuation | RA6.1.4 Process Inventory Count Adjustments |
| R2A - Record | Record to Analyse | Record and Account | RA6.0 Inventory Accounting | RA6.2 Inventory Provisions | RA6.2.1 Identify and Prepare Inventory Provisions |
| R2A - Record | Record to Analyse | Record and Account | RA7.0 Sales Accounting | RA7.1 Sales Accounting | RA7.1.1 Issue Sundry Invoice |
| R2A - Record | Record to Analyse | Record and Account | RA8.0 Treasury | RA8.1 Manage Bank Accounts | RA8.1.1 Process Bank Account Opening |
| R2A - Record | Record to Analyse | Record and Account | RA8.0 Treasury | RA8.1 Manage Bank Accounts | RA8.1.2 Process Bank Account Closing |
| R2A - Record | Record to Analyse | Record and Account | RA8.0 Treasury | RA8.2 Loans and Deposits | RA8.2.1 Intercomp. Loan and Deposit |
| R2A - Record | Record to Analyse | Record and Account | RA8.0 Treasury | RA8.2 Loans and Deposits | RA8.2.2 External Loan and Deposit |
| R2A - Record | Record to Analyse | Record and Account | RA8.0 Treasury | RA8.3 Hedging | RA8.3.1 Hedging Calculation |
| R2A - Record | Record to Analyse | Record and Account | RA8.0 Treasury | RA8.3 Hedging | RA8.3.2 FX Transaction |
| R2A - Record | Record to Analyse | Record and Account | RA8.0 Treasury | RA8.4 Cash Pooling | RA8.4.1 Internal Interest Calculation |
| R2A - Record | Record to Analyse | Record and Account | RA8.0 Treasury | RA8.5 Treasury Payment | RA8.5.1 Treasury Payment Release |
| R2A - Record | Record to Analyse | Record and Account | RA8.0 Treasury | RA8.5 Treasury Payment | RA8.5.2 Treasury Payment Monitoring |
| R2A - Record | Record to Analyse | Record and Account | RA8.0 Treasury | RA8.6 Netting | RA8.6.1 Intercompany Netting |
| R2A - Record | Record to Analyse | Record and Account | RA9.0 Intercompany | RA9.1 Intercompany Reconciliation | RA9.1.1 Reconcile Intercompany - Pre Close |
| R2A - Record | Record to Analyse | Record and Account | RA9.0 Intercompany | RA9.1 Intercompany Reconciliation | RA9.1.2 Reconcile Intercompany - Period End Close |
| R2A - Record | Record to Analyse | Record and Account | RA9.0 Intercompany | RA9.1 Intercompany Reconciliation | RA9.1.3 Reconcile Intercompany - Period End Lock |
| R2A - Record | Record to Analyse | Record and Account | RA10.0 Manage Records | RA10.1 Archive Documents | RA10.1.1 Archive Documents |
| R2A - Record | Record to Analyse | Record and Account | RA10.0 Manage Records | RA10.2 Retrieve Documents | RA10.2.1 Retrieve Documents |
| R2A - Record | Record to Analyse | Record and Account | RA10.0 Manage Records | RA10.3 Destroy Documents | RA10.3.1 Destroy Archived Documents |
| R2A - Close | Record to Analyse | Close | CL1.0 Master Data Integrity | CL1.1 Review Master Data Integrity | CL1.1.1 Review Master Data Technology Integration |
| R2A - Close | Record to Analyse | Close | CL1.0 Master Data Integrity | CL1.1 Review Master Data Integrity | CL1.1.2 Master Data Quality Control |
| R2A - Close | Record to Analyse | Close | CL1.0 Master Data Integrity | CL1.2 Master Data Integrity Reporting | CL1.2.1 Prepare Master Data Integrity Report |
| R2A - Close | Record to Analyse | Close | CL2.0 Close Sub Ledgers | CL2.1 Close Subledgers | CL2.1.1 Process Period Close AP |
| R2A - Close | Record to Analyse | Close | CL2.0 Close Sub Ledgers | CL2.1 Close Subledgers | CL2.1.2 Process Period Close AR |
| R2A - Close | Record to Analyse | Close | CL2.0 Close Sub Ledgers | CL2.1 Close Subledgers | CL2.1.3 Process Period Close Inventory |
| R2A - Close | Record to Analyse | Close | CL3.0 Period Close Entries | CL3.1 Period Close Entries | CL3.1.1 Review Preliminary Trial Balance |
| R2A - Close | Record to Analyse | Close | CL3.0 Period Close Entries | CL3.1 Period Close Entries | CL3.1.2 Prepare Manual Accrual |
| R2A - Close | Record to Analyse | Close | CL3.0 Period Close Entries | CL3.1 Period Close Entries | CL3.1.3 Prepare Manual Prepayment |
| R2A - Close | Record to Analyse | Close | CL3.0 Period Close Entries | CL3.1 Period Close Entries | CL3.1.4 Prepare Automated Accrual/Prepayment |
| R2A - Close | Record to Analyse | Close | CL3.0 Period Close Entries | CL3.1 Period Close Entries | CL3.1.5 Prepare Provision |
| R2A - Close | Record to Analyse | Close | CL3.0 Period Close Entries | CL3.1 Period Close Entries | CL3.1.6 Prepare Cost Center Allocation |
| R2A - Close | Record to Analyse | Close | CL3.0 Period Close Entries | CL3.1 Period Close Entries | CL3.1.7 Prepare FX Revaluation Adjustment |
| R2A - Close | Record to Analyse | Close | CL3.0 Period Close Entries | CL3.1 Period Close Entries | CL3.1.8 Prep. Def.Tax Asset/Liab. |
| R2A - Close | Record to Analyse | Close | CL4.0 Reconciliation | CL4.1 Trial Balance Reconciliation | CL4.1.1 Reconcile Account - Balance Managed |
| R2A - Close | Record to Analyse | Close | CL4.0 Reconciliation | CL4.1 Trial Balance Reconciliation | CL4.1.2 Reconcile Account - Open Items Managed |
| R2A - Close | Record to Analyse | Close | CL4.0 Reconciliation | CL4.2 Bank Reconciliation | CL4.2.1 Bank Posting and Reconciliation |
| R2A - Close | Record to Analyse | Close | CL4.0 Reconciliation | CL4.3 Third Party Reconciliation | CL4.3.1 Perform Vendor-Cust. Set. |
| R2A - Close | Record to Analyse | Close | CL4.0 Reconciliation | CL4.4 Sub-Ledgers to GL Reconciliation | CL4.4.1 Reconcile Sub-Ledgers to GL |
| R2A - Close | Record to Analyse | Close | CL4.0 Reconciliation | CL4.5 GRIR Analysis | CL4.5.1 Goods Received and no Invoice or Credit |
| | | | | | Note Received |
| R2A - Close | Record to Analyse | Close | CL4.0 Reconciliation | CL4.5 GRIR Analysis | CL4.5.2 Invoice Received and no Goods Received |
| R2A - Close | Record to Analyse | Close | CL4.0 Reconciliation | CL4.5 GRIR Analysis | CL4.5.3 Mismatch GR > IR |
| R2A - Close | Record to Analyse | Close | CL4.0 Reconciliation | CL4.5 GRIR Analysis | CL4.5.4 Mismatch IR > GR |
| R2A - Close | Record to Analyse | Close | CL5.0 Adjustment Entries | CL5.1 Review Balance Sheet | CL5.1.1 Balance Sheet Adjustments |
| R2A - Close | Record to Analyse | Close | CL5.0 Adjustment Entries | CL5.2 Review Profit and Loss | CL5.2.1 Profit and Loss Adjustments |
| R2A - Close | Record to Analyse | Close | CL6.0 Close General Ledger | CL6.1 Close General Ledger | CL6.1.1 Process Period Close GL |
| R2A - Report | Record to Analyse | Report | RP1.0 Management Reporting | RP1.1 Management Reporting | RP1.1.1 Prepare Management Reporting |
| R2A - Report | Record to Analyse | Report | RP1.0 Management Reporting | RP1.2 Ad-hoc Reporting | RP1.2.1 Produce Ad-hoc Report |
| R2A - Report | Record to Analyse | Report | RP2.0 Financial Reporting | RP2.1 Financial Reporting P&L | RP2.1.1 Prepare Financial Reporting P&L |
| R2A - Report | Record to Analyse | Report | RP2.0 Financial Reporting | RP2.2 Financial Reporting BS | RP2.2.1 Prepare Financial Reporting BS |
| R2A - Report | Record to Analyse | Report | RP2.0 Financial Reporting | RP2.3 Financial Reporting Group GAAP | RP2.3.1 Prepare Pre Month End Mapping Change |
| R2A - Report | Record to Analyse | Report | RP2.0 Financial Reporting | RP2.3 Financial Reporting Group GAAP | RP2.3.2 Review Revenue Recognition |
| R2A - Report | Record to Analyse | Report | RP2.0 Financial Reporting | RP2.3 Financial Reporting Group GAAP | RP2.3.3 Prepare Monthly Group Report |
| | | | | | Manual Entries |
| R2A - Report | Record to Analyse | Report | RP2.0 Financial Reporting | RP2.3 Financial Reporting Group GAAP | RP2.3.4 Prepare Financial Reporting Group GAAP |
| | | | | | for consolidation |
| R2A - Report | Record to Analyse | Report | RP2.0 Financial Reporting | RP2.4 Accounting Cashflow Reporting | RP2.4.1 Prepare Accounting Cashflow Report |
| R2A - Report | Record to Analyse | Report | RP3.0 Statutory & Reg. Reporting | RP3.1 Statutory Reporting | RP3.1.1 Prepare Statutory Reporting |
| R2A - Report | Record to Analyse | Report | RP3.0 Statutory & Reg. Reporting | RP3.2 Regulatory Reporting | RP3.2.1 Prepare Regulatory Reporting |
| R2A - Report | Record to Analyse | Report | RP4.0 Treasury Reporting | RP4.1 Treasury Management Reporting | RP4.1.1 Prepare Treasury Cash Flow Report |
| R2A - Report | Record to Analyse | Report | RP4.0 Treasury Reporting | RP4.1 Treasury Management Reporting | RP4.1.2 Prepare FX Report |
| R2A - Report | Record to Analyse | Report | RP4.0 Treasury Reporting | RP4.1 Treasury Management Reporting | RA4.1.3 Bank offer evaluation |
| R2A - Report | Record to Analyse | Report | RP5.0 Tax Reporting | RP5.1 Tax Reporting | RP5.1.1 Prep.Sales Tax/VAT Ret. |
| R2A - Report | Record to Analyse | Report | RP5.0 Tax Reporting | RP5.1 Tax Reporting | RP5.1.2 Prep.Corp Inc. Tax Ret. |
| R2A - Report | Record to Analyse | Report | RP5.0 Tax Reporting | RP5.1 Tax Reporting | RP5.1.3 Prepare Property Tax Return |
| R2A - Report | Record to Analyse | Report | RP5.0 Tax Reporting | RP5.1 Tax Reporting | RP5.1.4 Prepare Witholding Tax Return |
| R2A - Report | Record to Analyse | Report | RP5.0 Tax Reporting | RP5.1 Tax Reporting | RP5.1.5 Prepare Excise Tax Ret. |
| R2A - Report | Record to Analyse | Report | RP5.0 Tax Reporting | RP5.1 Tax Reporting | RP5.1.6 Prepare PIT Return |
| R2A - Report | Record to Analyse | Report | RP5.0 Tax Reporting | RP5.1 Tax Reporting | RP5.1.7 Prep. Social Sec. Ret. |
| R2A - Report | Record to Analyse | Report | RP6.0 Query | RP6.1 Client Queries | RP6.1.1 Resolve Client Query |
| R2A - Report | Record to Analyse | Report | RP6.0 Query | RP6.2 Client Treasury Queries | RP6.2.1 Resolve Client Treasury Query |
| R2A - Report | Record to Analyse | Report | RP6.0 Query | RP6.3 Audit Request | RP6.3.1 Respond to Audit Request |
| R2A - Analyse & Action | Record to Analyse | Analyse | AN1.0 Revenue Analytics | AN1.1 Revenue Analysis | AN1.1.1 Prepare Revenue Analysis by |
| | | | | | Geo/Client/Product |
| R2A - Analyse & Action | Record to Analyse | Analyse | AN1.0 Revenue Analytics | AN1.1 Revenue Analysis | AN1.1.2 Prepare Revenue Forecast by |
| | | | | | Geo/Client/Product |
| R2A - Analyse & Action | Record to Analyse | Analyse | AN1.0 Revenue Analytics | AN1.2 Profitability Analysis | AN1.2.1 Prepare Profitability Analysis |
| | | | | | Geo/Client/Product |
| R2A - Analyse & Action | Record to Analyse | Analyse | AN1.0 Revenue Analytics | AN1.2 Profitability Analysis | AN1.2.2 Prepare Profitability Forecast |
| | | | | | Geo/Client/Product |
| R2A - Analyse & Action | Record to Analyse | Analyse | AN1.0 Revenue Analytics | AN1.3 Budgeting & Forecasting | AN1.3.1 Prepare and Update Budget |
| R2A - Analyse & Action | Record to Analyse | Analyse | AN1.0 Revenue Analytics | AN1.3 Budgeting & Forecasting | AN1.3.2 Prepare and Update P&L Forecast |
| R2A - Analyse & Action | Record to Analyse | Analyse | AN1.0 Revenue Analytics | AN1.4 Revenue Leakage | AN1.4.1 Review Sales Accounting |
| R2A - Analyse & Action | Record to Analyse | Analyse | AN1.0 Revenue Analytics | AN1.4 Revenue Leakage | AN1.4.2 Review Billable WIP |
| R2A - Analyse & Action | Record to Analyse | Analyse | AN2.0 Working Capital Analytics | AN2.1 Working Capital Analysis | AN2.1.1 Prepare Working Capital Analysis |
| R2A - Analyse & Action | Record to Analyse | Analyse | AN2.0 Working Capital Analytics | AN2.1 Working Capital Analysis | AN2.1.2 Prepare Working Capital Resources |
| | | | | | Allocation |
| R2A - Analyse & Action | Record to Analyse | Analyse | AN2.0 Working Capital Analytics | AN2.2 Cash Flow Analysis | AN2.2.1 Daily Treasury Management |
| R2A - Analyse & Action | Record to Analyse | Analyse | AN2.0 Working Capital Analytics | AN2.2 Cash Flow Analysis | AN2.2.2 Operational Cash Flow Budget |
| R2A - Analyse & Action | Record to Analyse | Analyse | AN2.0 Working Capital Analytics | AN2.2 Cash Flow Analysis | AN2.2.3 Operational Cash Flow Forecast |
| R2A - Analyse & Action | Record to Analyse | Analyse | AN2.0 Working Capital Analytics | AN2.2 Cash Flow Analysis | AN2.2.4 Operational Cash Targets set up |
| R2A - Analyse & Action | Record to Analyse | Analyse | AN2.0 Working Capital Analytics | AN2.2 Cash Flow Analysis | AN2.2.5 Operational Actual Cash Flow Analysis |
| R2A - Analyse & Action | Record to Analyse | Analyse | AN2.0 Working Capital Analytics | AN2.2 Cash Flow Analysis | AN2.2.6 Bank interest/fees analysis |
| R2A - Analyse & Action | Record to Analyse | Analyse | AN2.0 Working Capital Analytics | AN2.2 Cash Flow Analysis | AN2.2.7 Loans and deposits interest analysis |
| R2A - Analyse & Action | Record to Analyse | Analyse | AN2.0 Working Capital Analytics | AN2.2 Cash Flow Analysis | AN2.2.8 Cash pooling interest analysis |
| R2A - Analyse & Action | Record to Analyse | Analyse | AN2.0 Working Capital Analytics | AN2.2 Cash Flow Analysis | AN2.2.9 Spread analysis |
| R2A - Analyse & Action | Record to Analyse | Analyse | AN2.0 Working Capital Analytics | AN2.2 Cash Flow Analysis | AN2.2.10 Interest and currency swaps analysis |
| R2A - Analyse & Action | Record to Analyse | Analyse | AN3.0 Control Analytics | AN3.1 Fin. Compliance & Control (SOX) | AN3.1.1 Prepare Internal Compliance Proceduresce |
| R2A - Analyse & Action | Record to Analyse | Analyse | AN3.0 Control Analytics | AN3.1 Fin. Compliance & Control (SOX) | AN3.1.2 Prepare Controls Compliance |
| R2A - Analyse & Action | Record to Analyse | Analyse | AN3.0 Control Analytics | AN3.1 Fin. Compliance & Control (SOX) | AN3.1.3 Prepare SOX Compliance |
| R2A - Analyse & Action | Record to Analyse | Analyse | AN3.0 Control Analytics | AN3.2 Enterprise Risk Management | AN3.2.1 Analyse Enterprise Risk Management |
| R2A - Analyse & Action | Record to Analyse | Analyse | AN3.0 Control Analytics | AN3.3 Real Time Control Analysis | AN3.3.1 Analyse Real Time Control |
| R2A - Analyse & Action | Record to Analyse | Analyse | AN4.0 Expense Analytics | AN4.1 Cost Analysis | AN4.1.1 Prepare Fixed Cost Analysis |
| R2A - Analyse & Action | Record to Analyse | Analyse | AN4.0 Expense Analytics | AN4.1 Cost Analysis | AN4.1.2 Prepare Variable Cost Analysis |
| R2A - Analyse & Action | Record to Analyse | Analyse | AN4.0 Expense Analytics | AN4.1 Cost Analysis | AN4.1.3 Prepare Cost Accounting Analysis |
| R2A - Analyse & Action | Record to Analyse | Analyse | AN4.0 Expense Analytics | AN4.1 Cost Analysis | AN4.1.4 Prepare Cost Forecast |
| R2A - Analyse & Action | Record to Analyse | Analyse | AN4.0 Expense Analytics | AN4.2 Spend Analysis | AN4.2.1 Prepare Spend Analysis |
| R2A - Analyse & Action | Record to Analyse | Analyse | AN4.0 Expense Analytics | AN4.3 Dupe. Payment Analy. & Recovery | AN4.3.1 Analyse Duplicate Payment & Recover |
| R2A - Analyse & Action | Record to Analyse | Analyse | AN4.0 Expense Analytics | AN4.4 Contract Compliance & Recovery | AN4.4.1 Analyse Contract Compliance & Recover |
| Master Data | Source to Pay | Accounts Payable | AP1.0 Master Data | AP1.1 Maintain Vendor Data | AP1.1.1 Process Vendor Maintenance Request |
| Master Data | Source to Pay | Accounts Payable | AP1.0 Master Data | AP1.2 Cleanse Vendor Master Data | AP1.2.1 Review and Cleanse Vendor Master Data |
| Invoice Processing | Source to Pay | Accounts Payable | AP2.0 Pre-Process | AP2.1 Receive and Scan Documents | AP2.1.1 Receive and Scan Documents |
| Invoice Processing | Source to Pay | Accounts Payable | AP2.0 Pre-Process | AP2.2 Inv. Pre-Process - Manual | AP2.2.1 Perform Manual Indexing |
| Invoice Processing | Source to Pay | Accounts Payable | AP2.0 Pre-Process | AP2.3 Inv. Pre-Process - Electronic | AP2.3.1 Receive EDI Invoices |
| Invoice Processing | Source to Pay | Accounts Payable | AP2.0 Pre-Process | AP2.3 Inv. Pre-Process - Electronic | AP2.3.2 Receive Email Invoice |
| Invoice Processing | Source to Pay | Accounts Payable | AP2.0 Pre-Process | AP2.3 Inv. Pre-Process - Electronic | AP2.3.3 Perform OCR Verification |
| Invoice Processing | Source to Pay | Accounts Payable | AP2.0 Pre-Process | AP2.4 E-Invoicing (EIPP) | AP2.4.1 Receive E-Invoicing |
| Invoice Processing | Source to Pay | Accounts Payable | AP3.0 Capture | AP3.1 Capture | AP3.1.1 Capture |
| Invoice Processing | Source to Pay | Accounts Payable | AP4.0 Authorise | AP4.1 PO Invoices | AP4.1.1 Process PO Invoice - 3 Way Match |
| Invoice Processing | Source to Pay | Accounts Payable | AP4.0 Authorise | AP4.1 PO Invoices | AP4.1.2 Process PO Invoice - 2 Way Match |
| Invoice Processing | Source to Pay | Accounts Payable | AP4.0 Authorise | AP4.2 Non-PO Invoices | AP4.2.1 Process Non-PO Invoice |
| Invoice Processing | Source to Pay | Accounts Payable | AP4.0 Authorise | AP4.2 Non-PO Invoices | AP4.2.2 Process Advance Invoice Payment |
| Invoice Processing | Source to Pay | Accounts Payable | AP4.0 Authorise | AP4.2 Non-PO Invoices | AP4.2.3 Process Recurring Invoice |
| Invoice Processing | Source to Pay | Accounts Payable | AP4.0 Authorise | AP4.3 ERS Invoice | AP4.3.1 Process ERS Invoice |
| P2P Helpdesk | Source to Pay | Accounts Payable | AP5.0 Query | AP5.1 Vendor Queries | AP5.1.1 Resolve Vendor Queries |
| P2P Helpdesk | Source to Pay | Accounts Payable | AP5.0 Query | AP5.2 Statements and Reminders | AP5.2.1 Process Vendor Statement |
| P2P Helpdesk | Source to Pay | Accounts Payable | AP5.0 Query | AP5.2 Statements and Reminders | AP5.2.2 Process Vendor Reminder |
| Invoice Processing | Source to Pay | Accounts Payable | AP6.0 Payment | AP6.1 Electronic Payment | AP6.1.1 Process Electronic Payment |
| Invoice Processing | Source to Pay | Accounts Payable | AP6.0 Payment | AP6.1 Electronic Payment | AP6.1.2 Process Direct Debit |
| Invoice Processing | Source to Pay | Accounts Payable | AP6.0 Payment | AP6.2 Manual Payment | AP6.2.1 Process Cheque Payment |
| Invoice Processing | Source to Pay | Accounts Payable | AP6.0 Payment | AP6.2 Manual Payment | AP6.2.2 Process Urgent Manual Payment |
| Invoice Processing | Source to Pay | Accounts Payable | AP6.0 Payment | AP6.2 Manual Payment | AP6.2.3 Void Cheque and Re-issue Process |
| P2P Helpdesk | Source to Pay | Accounts Payable | AP7.0 Reporting | AP7.1 Management Reporting | AP7.1.1 Perform Business Analysis |
| P2P Helpdesk | Source to Pay | Accounts Payable | AP7.0 Reporting | AP7.1 Management Reporting | AP7.1.2 Prepare Management Reports |
| P2P Helpdesk | Source to Pay | Accounts Payable | AP7.0 Reporting | AP7.2 Ad-hoc Reporting | AP7.2.1 Prepare Ad-hoc Report |
| Invoice Processing | Source to Pay | Accounts Payable | AP8.0 Document Management | AP8.1 Archive Documents | AP8.1.1 Archive Document |
| Invoice Processing | Source to Pay | Accounts Payable | AP8.0 Document Management | AP8.2 Retrieve Documents | AP8.2.1 Retrieve Document |
| Invoice Processing | Source to Pay | Accounts Payable | AP8.0 Document Management | AP8.3 Destroy Documents | AP8.3.1 Destroy Archived Document |
| Master Data | Source to Pay | Travel and Expense | TE1.0 Master Data | TE1.1 Maintain Employee Data | TE1.1.1 Process Employee Data Request |
| Master Data | Source to Pay | Travel and Expense | TE1.0 Master Data | TE1.2 Cleanse Employee MD | TE1.2.1 Review and Cleanse Employee MD |
| Master Data | Source to Pay | Travel and Expense | TE1.0 Master Data | TE1.3 Corporate Card Administration | TE1.3.1 Issue Corporate Card |
| Master Data | Source to Pay | Travel and Expense | TE1.0 Master Data | TE1.3 Corporate Card Administration | TE1.3.2 Suspend Re-instate Corporate Card |
| Master Data | Source to Pay | Travel and Expense | TE1.0 Master Data | TE1.3 Corporate Card Administration | TE1.3.3 Process Corporate Card Cancellation |
| Invoice Processing | Source to Pay | Travel and Expense | TE2.0 Pre-Process | TE2.1 Pre-Process Claim | TE2.1.1 Receive Manual Claim |
| Invoice Processing | Source to Pay | Travel and Expense | TE2.0 Pre-Process | TE2.1 Pre-Process Claim | TE2.1.2 Receive Electronic Claim |
| Invoice Processing | Source to Pay | Travel and Expense | TE3.0 Capture | TE3.1 Claim Processing | TE3.1.1 Process Manual and Electronic Claim |
| P2P Helpdesk | Source to Pay | Travel and Expense | TE4.0 Query | TE4.1 Resolve Queries | TE4.1.1 Resolve Incoming Query |
| Invoice Processing | Source to Pay | Travel and Expense | TE5.0 Payment | TE5.1 Process Payments | TE5.1.1 Process Payments of Employee Expenses |
| P2P Helpdesk | Source to Pay | Travel and Expense | TE6.0 Reporting | TE6.1 Management Reporting | TE6.1.1 Prepare Management Reports |
| Invoice Processing | Source to Pay | Travel and Expense | TE7.0 Document Management | TE7.1 Archive Documents | TE7.1.1 Archive and Destroy Documents |
| Invoice Processing | Source to Pay | Travel and Expense | TE7.0 Document Management | TE7.1 Archive Documents | TE7.1.2 Retrieve Documents |
| P2P Helpdesk | Source to Pay | Audit and Recovery | AU1.0 Perform Audit | AU1.1 AP Audits | AU1.1.1 Audit of Duplicate Posting Report |
| P2P Helpdesk | Source to Pay | Audit and Recovery | AU1.0 Perform Audit | AU1.1 AP Audits | AU1.1.2 Audit of AP Sample Data |
| P2P Helpdesk | Source to Pay | Audit and Recovery | AU1.0 Perform Audit | AU1.1 AP Audits | AU1.1.3 Audit of Blocked Invoices Report |
| P2P Helpdesk | Source to Pay | Audit and Recovery | AU1.0 Perform Audit | AU1.1 AP Audits | AU1.1.4 Audit of AP Master Data Records |
| P2P Helpdesk | Source to Pay | Audit and Recovery | AU1.0 Perform Audit | AU1.1 AP Audits | AU1.1.5 Audit of Service Invoices |
| P2P Helpdesk | Source to Pay | Audit and Recovery | AU1.0 Perform Audit | AU1.2 TE Audits | AU1.2.1 TE Pre-Payment Audit |
| P2P Helpdesk | Source to Pay | Audit and Recovery | AU1.0 Perform Audit | AU1.2 TE Audits | AU1.2.2 TE Post-Payment Audit |
| P2P Helpdesk | Source to Pay | Audit and Recovery | AU1.0 Perform Audit | AU1.2 T&E Audits | AU1.2.3 Audit of TE Duplicate Transactions |
| P2P Helpdesk | Source to Pay | Audit and Recovery | AU2.0 Perform Recoveries | AU2.1 AP Recoveries | AU2.1.1 Control AP Discount Lost |
| P2P Helpdesk | Source to Pay | Audit and Recovery | AU2.0 Perform Recoveries | AU2.1 AP Recoveries | AU2.1.2 Review Vendor Debit Balances |
| P2P Helpdesk | Source to Pay | Audit and Recovery | AU2.0 Perform Recoveries | AU2.2 TE Recoveries | AU2.2.1 Review TE Aging Report |
| Buyer | Source to Pay | Operational Procurement | OP1.0 PR to PO | OP1.1 Create PR | OP1.1.1 Generate Replenishment or Direct |
| | | | | | Material Request |
| Buyer | Source to Pay | Operational Procurement | OP1.0 PR to PO | OP1.1 Create PR | OP1.1.2A Create Catalog PR - Solution A |
| Buyer | Source to Pay | Operational Procurement | OP1.0 PR to PO | OP1.1 Create PR | OP1.1.2B Create Catalog PR - Solution B |
| Buyer | Source to Pay | Operational Procurement | OP1.0 PR to PO | OP1.1 Create PR | OP1.1.3A Create Non-catalog PR - Solution A |
| Buyer | Source to Pay | Operational Procurement | OP1.0 PR to PO | OP1.1 Create PR | OP1.1.3B Create Non-catalog PR - Solution B |
| Buyer | Source to Pay | Operational Procurement | OP1.0 PR to PO | OP1.1 Create PR | OP1.1.4 Purchase with P-card |
| Buyer | Source to Pay | Operational Procurement | OP1.0 PR to PO | OP1.1 Create PR | OP1.1.5 Process Emergency Request |
| Buyer | Source to Pay | Operational Procurement | OP1.0 PR to PO | OP1.2 Approve PR | OP1.2.1A Approve PR - Solution A |
| Buyer | Source to Pay | Operational Procurement | OP1.0 PR to PO | OP1.2 Approve PR | OP1.2.1B Approve PR - Solution B |
| Buyer | Source to Pay | Operational Procurement | OP1.0 PR to PO | OP1.3 Process PR | OP1.3.1A Validate PR - Solution A |
| Buyer | Source to Pay | Operational Procurement | OP1.0 PR to PO | OP1.3 Process PR | OP1.3.1B Validate PR - Solution B |
| Buyer | Source to Pay | Operational Procurement | OP1.0 PR to PO | OP1.3 Process PR | OP1.3.2 Perform Low Threshold Request for Quote |
| Buyer | Source to Pay | Operational Procurement | OP1.0 PR to PO | OP1.3 Process PR | OP1.3.3 Perform Spot Buy (Competitive Bidding) |
| Buyer | Source to Pay | Operational Procurement | OP1.0 PR to PO | OP1.3 Process PR | OP1.3.4A Convert PR to PO - Solution A |
| Buyer | Source to Pay | Operational Procurement | OP1.0 PR to PO | OP1.3 Process PR | OP1.3.5A Change or Cancel PR - Solution A |
| Buyer | Source to Pay | Operational Procurement | OP1.0 PR to PO | OP1.3 Process PR | OP1.3.5B Change or Cancel PR - Solution B |
| Buyer | Source to Pay | Operational Procurement | OP1.0 PR to PO | OP1.4 Process PO | OP1.4.1A Approve PO - Solution A |
| Buyer | Source to Pay | Operational Procurement | OP1.0 PR to PO | OP1.4 Process PO | OP1.4.2 Transmit PO or Delivery Schedule |
| Buyer | Source to Pay | Operational Procurement | OP1.0 PR to PO | OP1.4 Process PO | OP1.4.3A Change or Cancel PO - Solution A |
| Buyer | Source to Pay | Operational Procurement | OP1.0 PR to PO | OP1.4 Process PO | OP1.4.4 Process Order Acknowledgement |
| Buyer | Source to Pay | Operational Procurement | OP2.0 Delivery Management | OP2.1 Monitor Delivery | OP2.1.1 Receive Advanced Shipment Notification |
| Buyer | Source to Pay | Operational Procurement | OP2.0 Delivery Management | OP2.1 Monitor Delivery | OP2.1.2 Monitor Delivery and Expedite |
| Buyer | Source to Pay | Operational Procurement | OP2.0 Delivery Management | OP2.2 Receive Goods/Services | OP2.2.1 Verify Goods or Services |
| Buyer | Source to Pay | Operational Procurement | OP2.0 Delivery Management | OP2.2 Receive Goods/Services | OP2.2.2 Receipt Goods or Services |
| Buyer | Source to Pay | Operational Procurement | OP2.0 Delivery Management | OP2.3 Returns/Warranties/Claims | OP2.3.1 Manage Return |
| Buyer | Source to Pay | Operational Procurement | OP2.0 Delivery Management | OP2.3 Returns/Warranties/Claims | OP2.3.2 Manage Claim or Warranty |
| Master Data | Source to Pay | Master Data | MD1.0 Vendor Master Data | MD1.1 Vendor Master Data | MD1.1.1 Maintain Vendor Master Data |
| Master Data | Source to Pay | Master Data | MD1.0 Vendor Master Data | MD1.1 Vendor Master Data | MD1.1.2 Review and Cleanse VMD |
| Master Data | Source to Pay | Master Data | MD2.0 Commodity MD | MD2.1 Commodity MD | MD2.1.1 Maintain Commodity Master Data |
| Master Data | Source to Pay | Master Data | MD2.0 Commodity MD | MD2.1 Commodity MD | MD2.1.2 Review and Cleanse CMD |
| Master Data | Source to Pay | Master Data | MD3.0 BOM Master Data | MD3.1 BOM Master Data | MD3.1.1 Maintain BOM Master Data |
| Master Data | Source to Pay | Master Data | MD4.0 Master Data Mapping | MD4.1 Master Data Mapping | MD4.1.1 Maintain Buyer Assignment Mapping |
| Master Data | Source to Pay | Master Data | MD4.0 Master Data Mapping | MD4.1 Master Data Mapping | MD4.1.2 Maintain Commodity to GL Mapping |
| Master Data | Source to Pay | Master Data | MD4.0 Master Data Mapping | MD4.1 Master Data Mapping | MD4.1.3 Maintain Info Record |
| Master Data | Source to Pay | Master Data | MD4.0 Master Data Mapping | MD4.1 Master Data Mapping | MD4.1.4 Maintain Source List |
| Master Data | Source to Pay | Master Data | MD4.0 Master Data Mapping | MD4.1 Master Data Mapping | MD4.1.5 Maintain Other Mapping |
| Master Data | Source to Pay | Master Data | MD5.0 Approval Workflow | MD5.1 Approval Workflow | MD5.1.1 Maintain Authorization Matrix |
| Master Data | Source to Pay | Master Data | MD6.0 User Data | MD6.1 User Data Management | MD6.1.1 Maintain P-cards User Data |
| Master Data | Source to Pay | Master Data | MD6.0 User Data | MD6.1 User Data Management | MD6.1.2 Maintain System User Data |
| Master Data | Source to Pay | Master Data | MD7.0 Catalogs Maintenance | MD7.1 Catalogs Maintenance | MD7.1.1 Maintain Catalog |
| Master Data | Source to Pay | Master Data | MD8.0 Contract Data | MD8.1 Contract Data | MD8.1.1 Maintain Contract Master Data |
| Master Data | Source to Pay | Master Data | MD9.0 Create Blanket/Framewk Ord. | MD9.1 Create Blanket/Framework Order | MD9.1.1 Maintain Blanket Order |
| Master Data | Source to Pay | Master Data | MD9.0 Create Blanket/Framewk Ord. | MD9.1 Create Blanket/Framework Order | MD9.1.2 Maintain Framework Order |
| P2P Helpdesk | Source to Pay | Service Desk | SD1.0 Queries | SD1.1 Manage Queries | SD1.1.1 Process and Resolve Queries |
| P2P Helpdesk | Source to Pay | Service Desk | SD2.0 Helpdesk Services | SD2.1 Vendor Enablement | SD2.1.1 Perform Vendor Activation |
| P2P Helpdesk | Source to Pay | Service Desk | SD2.0 Helpdesk Services | SD2.2 Assisted Buy [on behalf of] | SD2.2.1 Perform Assisted Buying [on behalf of] |
| P2P Helpdesk | Source to Pay | Service Desk | SD2.0 Helpdesk Services | SD2.3 GR Entry [on behalf of] | SD2.3.1 Perform GR Entry [on behalf of] |
| P2P Helpdesk | Source to Pay | Service Desk | SD2.0 Helpdesk Services | SD2.4 Invoice Mismatch Resolution | SD2.4.1 Resolve Invoice Mismatch |
| P2P Helpdesk | Source to Pay | Service Desk | SD2.0 Helpdesk Services | SD2.5 Promote Compliant Behaviors | SD2.5.1 Promote Compliant Behaviors |
| P2P Helpdesk | Source to Pay | Report and Analyse | RA1.0 Define Report | RA1.1 Define Report | RA1.1.1 Define Report |
| P2P Analyse & Actions | Source to Pay | Report and Analyse | RA2.0 Execute Service Reporting | RA2.1 Execute Service Reporting | RA2.1.1 Execute SLA Reporting |
| P2P Analyse & Actions | Source to Pay | Report and Analyse | RA2.0 Execute Service Reporting | RA2.1 Execute Service Reporting | RA2.1.2 Execute Operational Reporting |
| P2P Analyse & Actions | Source to Pay | Report and Analyse | RA3.0 Execute Inventory Reporting | RA3.1 Execute Inventory Reporting | RA3.1.1 Monitor Stock Obsolescence Risk |
| P2P Analyse & Actions | Source to Pay | Report and Analyse | RA3.0 Execute Inventory Reporting | RA3.1 Execute Inventory Reporting | RA3.1.2 Optimise Stockholding |
| P2P Analyse & Actions | Source to Pay | Report and Analyse | RA4.0 Exec. Client-specific Reporting | RA4.1 Execute Client-specific Reporting | RA4.1.1 Execute Client-specific Reporting |
| P2P Analyse & Actions | Source to Pay | Report and Analyse | RA5.0 Exec. Benfts. & Compl. Trackng | RA5.1 Exec. Benfts. & Compl. Trackng | RA5.1.1 Perform Benefits Tracking |
| P2P Analyse & Actions | Source to Pay | Report and Analyse | RA5.0 Exec. Benfts. & Compl. Trackng | RA5.1 Exec. Benfts. & Compl. Trackng | RA5.1.2 Execute Purchasing Policy Compliance |
| | | | | | Reporting |
| P2P Analyse & Actions | Source to Pay | Report and Analyse | RA5.0 Exec. Benfts. & Compl. Trackng | RA5.1 Exec. Benfts. & Compl. Trackng | RA5.1.3 Execute Contract Compliance Reporting |
| P2P Analyse & Actions | Source to Pay | Report and Analyse | RA5.0 Exec. Benfts. & Compl. Trackng | RA5.1 Exec. Benfts. & Compl. Trackng | RA5.1.4 Execute Statutory Regulation Compliance |
| | | | | | Reporting |
| P2P Analyse & Actions | Source to Pay | Report and Analyse | RA6.0 Execute Channel Mgmt | RA6.1 Execute Channel Management | RA6.1.1 Analyse Repeat Buy Non-catalog Items |
| P2P Analyse & Actions | Source to Pay | Report and Analyse | RA6.0 Execute Channel Mgmt | RA6.1 Execute Channel Management | RA6.1.2 Audit Punch-out (Web-shop) Catalog |
| | | | | | Changes |
| P2P Analyse & Actions | Source to Pay | Report and Analyse | RA6.0 Execute Channel Mgmt | RA6.1 Execute Channel Management | RA6.1.3 Review and Recommend Buying Channels |
| P2P Analyse & Actions | Source to Pay | Report and Analyse | RA6.0 Execute Channel Mgmt | RA6.1 Execute Channel Management | RA6.1.4 Analyse and Recommend Vendor |
| | | | | | Rationalisation |
| P2P Analyse & Actions | Source to Pay | Report and Analyse | RA6.0 Execute Channel Mgmt | RA6.1 Execute Channel Management | RA6.1.5 Analyse and Recommend Content |
| | | | | | Rationalisation |

What is claimed is:

1. A global process optimization processor-implemented method, comprising:
obtaining a baseline process optimization request via a processor, including an unoptimized locally-deployable baseline process;
extracting, via the processor, the unoptimized locally-deployable baseline process into one or more resolved baseline sub-processes;
identifying, via the processor, sub-process templates matching the resolved baseline sub-processes using a matching procedure;
modifying the identified sub-process templates to generate custom globally optimized sub-processes;
storing in a database the modified custom globally optimized sub-processes; and
providing a notification of baseline process optimization in response to the baseline process optimization request.

2. The method of claim 1, wherein identifying sub-process templates matching the resolved baseline sub-processes using a matching procedure further comprises:
matching based on the compliance of the sub-process templates with a legal or regulatory requirement of the resolved baseline sub-processes.

3. The method of claim 2, wherein the legal or regulatory requirement is compliance with a financial regulation.

4. The method of claim 1, wherein identifying sub-process templates matching the resolved baseline sub-processes using a matching procedure further comprises:
matching based on the inputs of the sub-process templates and the resolved baseline sub-processes.

5. The method of claim 1, wherein identifying sub-process templates matching the resolved baseline sub-processes using a matching procedure further comprises:
matching based on the outputs of the sub-process templates and the resolved baseline sub-processes.

6. The method of claim 1 wherein the modifications to the identified sub-process templates are based on an impact assessment.

7. The method of claim 6 wherein the impact assessment is based on a score representing the compliance of the sub-process templates with legal or regulatory requirements of the unoptimized locally-deployable baseline process.

8. The method of claim 6 wherein the impact assessment is based on the similarity of inputs between the sub-process templates and the unoptimized locally-deployable baseline process.

9. The method of claim 6 wherein the impact assessment is based on the similarity of outputs between the sub-process templates and the unoptimized locally-deployable baseline process.

10. A global process optimization processor-implemented system, comprising:
means to obtain a baseline process optimization request via a processor, including an unoptimized locally-deployable baseline process;
means to extract, via the processor, the unoptimized locally-deployable baseline process into one or more resolved baseline sub-processes;
means to identify, via the processor, sub-process templates matching the resolved baseline sub-processes using a matching procedure;
means to modify the identified sub-process templates to generate custom globally optimized sub-processes;
means to store in a database the modified custom globally optimized sub-processes; and
means to provide a notification of baseline process optimization in response to the baseline process optimization request.

11. The system of claim 10, wherein means to identify sub-process templates matching the resolved baseline sub-processes using a matching procedure further comprises:
means to match based on the compliance of the sub-process templates with a legal or regulatory requirement of the resolved baseline sub-processes.

12. The system of claim 11, wherein the legal or regulatory requirement is compliance with a financial regulation.

13. The system of claim 10, wherein means to identify sub-process templates matching the resolved baseline sub-processes using a matching procedure further comprises:
means to match based on the inputs of the sub-process templates and the resolved baseline sub-processes.

14. The system of claim 10, wherein means to identify sub-process templates matching the resolved baseline sub-processes using a matching procedure further comprises:
means to match based on the outputs of the sub-process templates and the resolved baseline sub-processes.

15. The system of claim 10 wherein the means to modify the identified sub-process templates are based on an impact assessment.

16. The system of claim 15 wherein the impact assessment is based on a score representing the compliance of the sub-process templates with legal or regulatory requirements of the unoptimized locally-deployable baseline process.

17. The system of claim 15 wherein the impact assessment is based on the similarity of inputs between the sub-process templates and the unoptimized locally-deployable baseline process.

18. The system of claim 15 wherein the impact assessment is based on the similarity of outputs between the sub-process templates and the unoptimized locally-deployable baseline process.

19. A global process optimization apparatus, comprising:
a memory;
a processor disposed in communication with said memory, and configured to issue a plurality of processing instructions stored in the memory, wherein the processor issues instructions to:
obtain a baseline process optimization request via a processor, including an unoptimized locally-deployable baseline process;
extract, via the processor, the unoptimized locally-deployable baseline process into one or more resolved baseline sub-processes;
identify, via the processor, sub-process templates matching the resolved baseline sub-processes using a matching procedure;
modify the identified sub-process templates to generate custom globally optimized sub-processes;
store in a database the modified custom globally optimized sub-processes; and
provide a notification of baseline process optimization in response to the baseline process optimization request.

20. The apparatus of claim 19, whereby the instructions to identify sub-process templates matching the resolved baseline sub-processes using a matching procedure further comprises instructions to:
match based on the compliance of the sub-process templates with a legal or regulatory requirement of the resolved baseline sub-processes.

21. The apparatus of claim 20, wherein the legal or regulatory requirement is compliance with a financial regulation.

22. The apparatus of claim 19, whereby the instructions to identify sub-process templates matching the resolved baseline sub-processes using a matching procedure further comprises instructions to:
match based on the inputs of the sub-process templates and the resolved baseline sub-processes.

23. The apparatus of claim 19, whereby the instructions to identify sub-process templates matching the resolved baseline sub-processes using a matching procedure further comprises instructions to:
matching based on the outputs of the sub-process templates and the resolved baseline sub-processes.

24. The apparatus of claim 19 wherein the instructions to modify the identified sub-process templates are based on an impact assessment.

25. The apparatus of claim 24 wherein the impact assessment is based on a score representing the compliance of the sub-process templates with legal or regulatory requirements of the unoptimized locally-deployable baseline process.

26. The apparatus of claim 24 wherein the impact assessment is based on the similarity of inputs between the sub-process templates and the unoptimized locally-deployable baseline process.

27. The apparatus of claim 24 wherein the impact assessment is based on the similarity of outputs between the sub-process templates and the unoptimized locally-deployable baseline process.

28. A non-transitory medium storing processor-issuable global process optimization instructions to:
obtain a baseline process optimization request via a processor, including an unoptimized locally-deployable baseline process;
extract, via the processor, the unoptimized locally-deployable baseline process into one or more resolved baseline sub-processes;
identify, via the processor, sub-process templates matching the resolved baseline sub-processes using a matching procedure;
modify the identified sub-process templates to generate custom globally optimized sub-processes;
store in a database the modified custom globally optimized sub-processes; and
provide a notification of baseline process optimization in response to the baseline process optimization request.

29. The medium of claim 28, whereby the instructions to identify sub-process templates matching the resolved baseline sub-processes using a matching procedure further comprises instructions to:
match based on the compliance of the sub-process templates with a legal or regulatory requirement of the resolved baseline sub-processes.

30. The medium of claim 29, wherein the legal or regulatory requirement is compliance with a financial regulation.

31. The medium of claim 28, whereby the instructions to identify sub-process templates matching the resolved baseline sub-processes using a matching procedure further comprises instructions to:
match based on the inputs of the sub-process templates and the resolved baseline sub-processes.

32. The medium of claim 28, whereby the instructions to identify sub-process templates matching the resolved baseline sub-processes using a matching procedure further comprises instructions to:
matching based on the outputs of the sub-process templates and the resolved baseline sub-processes.

33. The medium of claim 28 wherein the instructions to modify the identified sub-process templates are based on an impact assessment.

34. The medium of claim 33 wherein the impact assessment is based on a score representing the compliance of the sub-process templates with legal or regulatory requirements of the unoptimized locally-deployable baseline process.

35. The medium of claim 33 wherein the impact assessment is based on the similarity of inputs between the sub-process templates and the unoptimized locally-deployable baseline process.

36. The medium of claim 33 wherein the impact assessment is based on the similarity of outputs between the sub-process templates and the unoptimized locally-deployable baseline process.

37. A global process optimization processor-implemented method, comprising:
obtaining a baseline process optimization request via a processor, including an unoptimized locally-deployable baseline process;
providing a notification of receipt of the baseline process optimization request;
obtaining a sub-process identification input;
resolving, via the processor, the unoptimized locally-deployable baseline process into one or more baseline sub-processes;
accessing a process template database for sub-process templates matching the resolved baseline sub-processes;
identifying, via the processor, sub-process templates matching the resolved baseline sub-processes using a matching procedure;
modifying, via the processor, the identified sub-process templates according impact determinations generated using the matching procedure to generate custom globally optimized sub-processes;
storing in a database the modified custom globally optimized sub-processes; and
providing a notification of baseline process optimization in response to the baseline process optimization request.
